(19) United States
(12) Patent Application Publication
(10) Pub. No.: US 2025/0150845 A1
(43) Pub. Date: May 8, 2025

(54) SYSTEMATIC AND SEMI DETERMINISTIC MAPPING BETWEEN SYNCHRONIZATION SIGNAL BLOCK IDS AND PHYSICAL TRANSMISSION BEAMS FOR MORE EFFICIENT BEAM MANAGEMENT

(71) Applicant: QUALCOMM Incorporated, San Diego, CA (US)

(72) Inventors: Michael LEVITSKY, Rehovot (IL); Daniel PAZ, Atlit (IL); Assaf TOUBOUL, Netanya (IL)

(21) Appl. No.: 18/837,841

(22) PCT Filed: Mar. 13, 2023
(86) PCT No.: PCT/US2023/015139

§ 371 Date: Aug. 12, 2024

(30) Foreign Application Priority Data
Apr. 5, 2022 (IL) 291967

(51) Int. Cl. H04W 16/28; H04B 7/06

(52) U.S. Cl. CPC H04W 16/28; H04B 7/063; H04B 7/06952

(57) ABSTRACT

Aspects presented herein may improve beam management and neighbor cell(s) monitoring related characteristics on a UE side, which may include improved power consumption, configuration volume reduction, and more robust and efficient beam tracking procedures for UEs receiving and monitoring SSBs transmitted by a base stations. In one aspect, a UE is configured to apply an SSB IDs classification based on a systematic mapping configuration that maps a set of SSB IDs to a plurality of SSB beams of a network entity, each SSB beam of the plurality of SSB beams being associated with one SSB ID of the set of SSB IDs and covering a range of azimuth angles and a range of elevation angles. Based on the mapping configuration and the semi-deterministic SSB beams sweeping pattern, the UE may classify SSB IDs into different categories and prioritize and deprioritize measurements for one or more SSB IDs.

### CROSS-REFERENCE TO RELATED APPLICATION

This application claims the benefit of Israel Patent Application No. 291967, entitled “SYSTEMATIC AND SEMI DETERMINISTIC MAPPING BETWEEN SYNCHRONIZATION SIGNAL BLOCK IDS AND PHYSICAL TRANSMISSION BEAMS FOR MORE EFFICIENT BEAM MANAGEMENT” and filed on Apr. 5, 2022, which is expressly incorporated by reference herein in its entirety.

### TECHNICAL FIELD

The present disclosure relates generally to communication systems, and more particularly, to wireless communication involving beam management.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus maps a set of synchronization signal block (SSB) identifiers (IDs) to a plurality of SSB beams based on a mapping configuration, each SSB beam of the plurality of SSB beams being associated with one SSB ID of the set of SSB IDs and covering a range of azimuth angles and a range of elevation angles. The apparatus transmits one or more SSB IDs via the plurality of SSB beams based at least in part on the mapping configuration.

In another aspect of the disclosure, a method, a computer-readable medium, and an apparatus are provided. The apparatus applies an SSB IDs classification based at least in part on a mapping configuration that maps a set of SSB IDs to a plurality of SSB beams of a network entity, each SSB beam of the plurality of SSB beams being associated with one SSB ID of the set of SSB IDs and covering a range of azimuth angles and a range of elevation angles. The apparatus prioritizes measurements for one or more SSB IDs transmitted via one or more of the plurality of SSB beams based at least in part on the mapping configuration and the SSB IDs classification.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example synchronization signal block (SSB) in accordance with various aspects of the present disclosure.

FIG. 5 is a diagram illustrating an example of information that may be included in a physical broadcast channel (PBCH) of an SSB in accordance with various aspects of the present disclosure.

FIG. 6 is a communication flow illustrating example SIB transmissions in accordance with various aspects of the present disclosure.

FIG. 7 is a diagram illustrating an example two-dimensional (2D) mapping/indexing of SSB beams based on azimuth and elevation angles in accordance with various aspects of the present disclosure.

FIG. 8 is a diagram illustrating an example mapping of SSB IDs based on the azimuth angles first and then the elevation angles in accordance with various aspects of the present disclosure.

FIG. 9 is a diagram illustrating an example mapping of SSB IDs based on the elevation angles first and then the azimuth angles in accordance with various aspects of the present disclosure.

FIG. 10 is a diagram illustrating an example of beam blocking in accordance with various aspects of the present disclosure.

FIG. 11 is a diagram illustrating an example of beam blocking in accordance with various aspects of the present disclosure.

FIG. 12 is a diagram illustrating an example of SSB ID to physical SSB beam mapping (sweep pattern) based on two levels of SSB beams sweeping in accordance with various aspects of the present disclosure.

FIG. 13 is a diagram illustrating an example of classification and prioritizing and/or down selecting SSB ID in accordance with various aspects of the present disclosure.

FIG. 14 is a flowchart of a method of wireless communication.

FIG. 15 is a diagram illustrating an example of a hardware implementation for an example apparatus and/or network entity.

FIG. 16 is a flowchart of a method of wireless communication.

FIG. 17 is a diagram illustrating an example of a hardware implementation for an example apparatus and/or network entity.

### DETAILED DESCRIPTION

Aspects presented herein may improve multiple beam management and neighbor cells monitoring related characteristics on a UE side including improved power consumption, configuration volume reduction, more robust and efficient beams tracking procedures for UEs monitoring and receiving SSBs transmitted by a base station or component(s) of a base station employing a systematic and semi-deterministic SSB beam sweeping pattern from UE's perspective. For example, one or more systematic beam sweeping patterns and/or directions (e.g. across azimuth and elevation directions) may be used and several related parameters defining two-dimensional (2D) beam sweep patterns may be indicated to a UE. Aspects presented herein may provide enhanced beam management procedures and neighboring cell measurement procedures from a UE's perspective at least with a reduced UE power and potentially longer UE sleep time durations. In addition, aspects presented herein may enable a UE to take a more active role in overall beam management (BM) processes, such as BFD, RLM, and/or BFR procedures for the communication link between the UE and the network (e.g., a UE is typically in a “slave” mode while a network providing to a UE different configurations is in a “master” mode for BM of the communication link in most network implementations). This in turn may enable RRC configuration volume and RRC reconfiguration rates to be reduced for a UE, and allow a more efficient serving and alternative beams tracking, and a more robust BFR and MPE related procedures. More robust, more efficient, and responsive beam tracking procedures on UE side may further allow an enhanced UE mobility and a more robust HO procedures.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

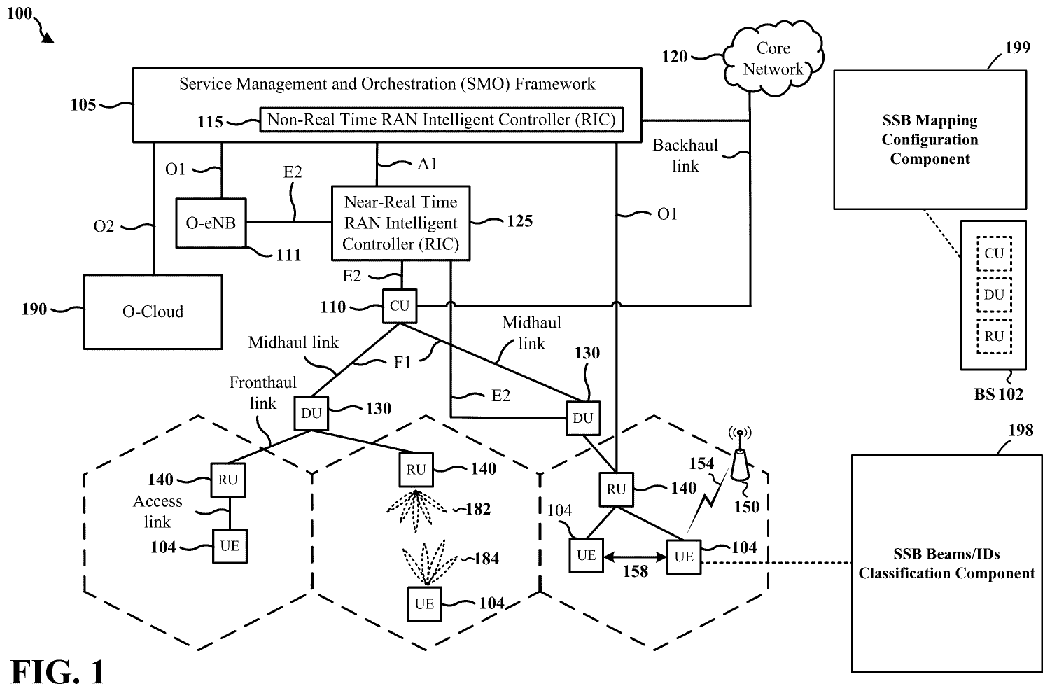

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include an SSB beams/IDs classification component 198 relying on SSB beams mapping configuration that can be configured to prioritize/deprioritize measurements of some SSB beams/IDs based on a two-dimensional (2D) mapping side information/configuration and SSB IDs classification into different categories. In one configuration, the SSB beams/IDs classification component 198 may apply an SSB IDs classification based at least in part on a mapping configuration that maps a set of SSB IDs to a plurality of SSB beams of a network entity, each SSB beam of the plurality of SSB beams being associated with one SSB ID of the set of SSB IDs and covering a range of azimuth angles and a range of elevation angles. In such configuration, the SSB beams/IDs classification component 198 may prioritize measurements for one or more SSB IDs transmitted via one or more of the plurality of SSB beams based at least in part on the mapping configuration and the SSB IDs classification.

In certain aspects, the base station 102 may include an SSB mapping configuration component 199 configured to map BBS IDs to a set of SSB beams based on a 2D mapping across azimuth and elevation directions. In one configuration, the SSB mapping configuration component 199 may map a set of SSB IDs to a plurality of SSB beams based on a systematic mapping configuration, each SSB beam of the plurality of SSB beams being associated with one SSB ID of the set of SSB IDs and covering a range of azimuth angles and a range of elevation angles. In such configuration, the SSB mapping configuration component 199 may transmit one or more SSB IDs via the plurality of SSB beams based at least in part on the systematic mapping configuration.

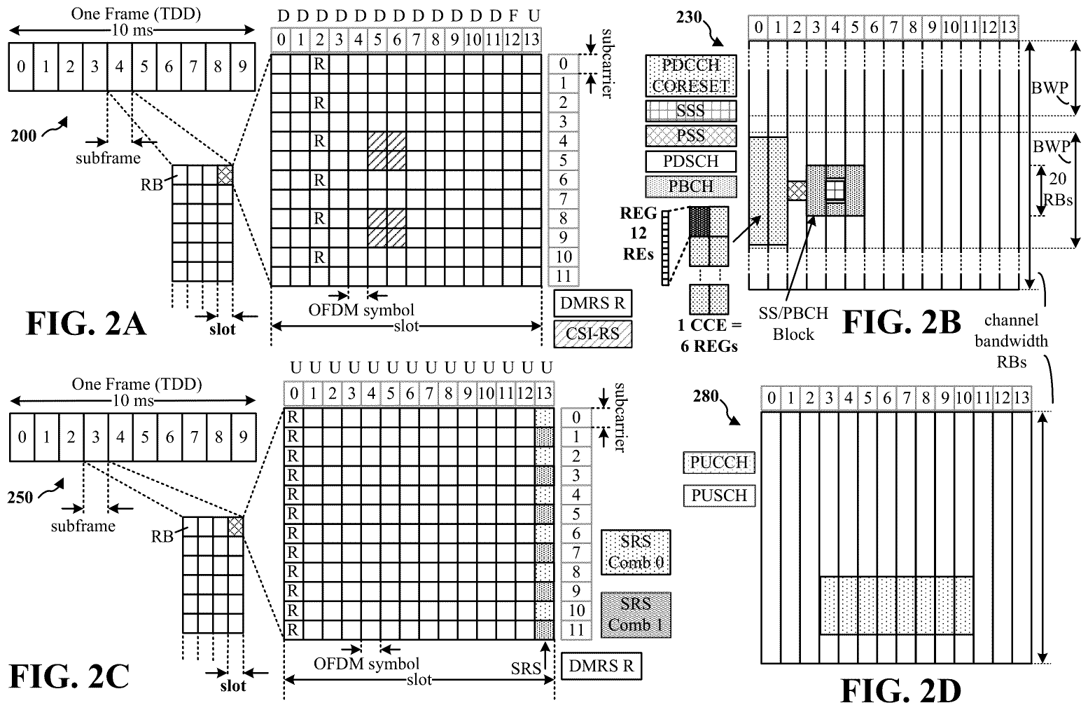

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology u=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

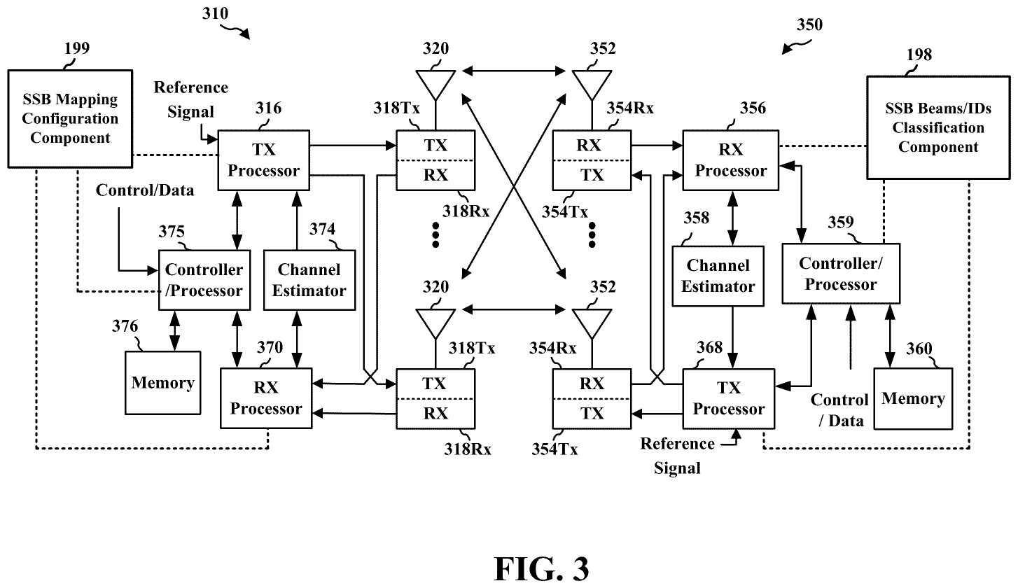

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the SSB mapping process component 198 of FIG. 1.

At least one of the TX processor 316, the RX processor 370, and the controller/processor 375 may be configured to perform aspects in connection with the SSB mapping configuration component 199 of FIG. 1.

A UE may perform a cell search to obtain time and/or frequency synchronization with a cell and to obtain a cell identifier (ID), such as a physical layer cell ID (PCI) of the cell. The UE may also measure the signal quality and obtain other information about the cell based on the PCI. The UE may perform the cell search for a defined frequency range before the UE selects or re-selects a cell. In some examples, a UE may perform the cell search when the UE is powered ON, when the UE is moving (e.g., under mobility in a connected mode), and/or when the UE is in an idle/inactive mode (e.g., the UE may perform a cell reselection procedure after the UE camps on a cell and stays in the idle mode), etc.

To perform the cell search (e.g., the initial cell search and/or the cell reselection, etc.), a UE may use/decode synchronization signal(s) transmitted from one or more cells (e.g., transmitted from a base station or a transmission reception point (TRP) of the base station), where the UE may obtain or derive information related to the one or more cells and/or their access information based on the synchronization signal(s). In one example, a cell may provide one or more types of synchronization signals, such as a primary synchronization signal (PSS) and a secondary synchronization signal (SSS), along with a physical broadcast channel (PBCH), in a synchronization signal block (SSB) to UEs within its transmission range, e.g., as described in connection with FIG. 2B. Then, the UEs may perform the cell search based on the SSB. In some examples, a UE may first decode a PBCH before the UE receives other system information transmitted on a physical downlink shared channel (PDSCH).

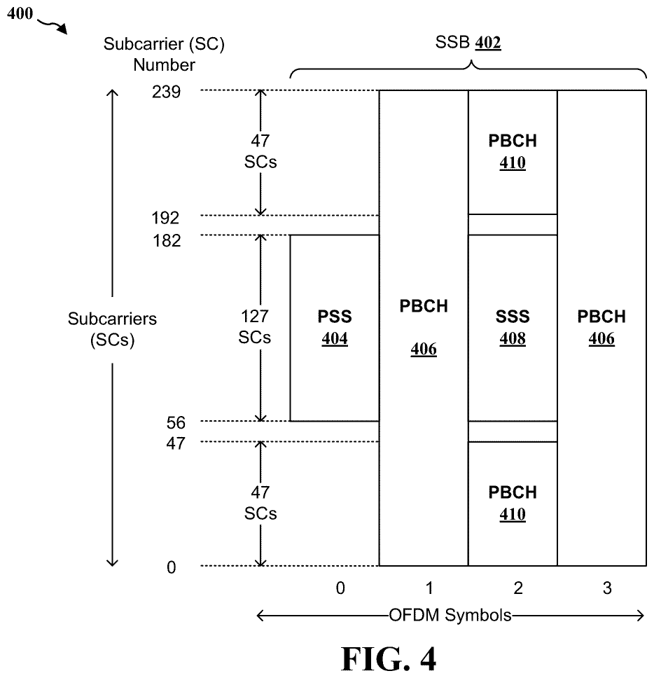

FIG. 4 is a diagram 400 illustrating an example SSB in accordance with various aspects of the present disclosure. An SSB 402 may span four (4) OFDM symbols with one (1) symbol for a PSS 404, two (2) symbols for PBCH 406, and one (1) symbol with an SSS 408 and PBCH 410 that are frequency division multiplexed (FDMed). The length of an OFDM symbol or a slot may be scaled based on subcarrier spacing (SCS), and there may be seven (7) or fourteen (14) symbols per slot. For example, different frequency ranges may have different SCS, where 15, 30, and/or 60 kHz SCS may be used for lower frequency bands (e.g., the FR1), and 60, 120, and/or 240 kHz SCS may be used for higher frequency bands (e.g., the FR2). In one example, the PSS 404 may be mapped to 127 subcarriers (SCs) around the center frequency of the SSB 402, where the PSS 404 may use a length 127 frequency domain-based M-sequence (e.g., made up of 127 M-sequence values), which may have up to three (3) possible sequences. The M-sequence may also be referred to as a maximum length sequence (MLS), which may be a type of pseudorandom binary sequence. The SSS 408 may also be mapped to 127 SCs and may use a length 127 frequency domain-based Gold Code sequence (e.g., two (2) M-sequences are used), which may have up to 1008 possible sequences. A UE may use the information included in the PSS 404 and/or the SSS 408 for downlink frame synchronization and for determining the physical cell ID of the cell. The PBCH 406 and/or 410 may be modulated with quadrature phase shift keying (QPSK), which may be coherently demodulated by a UE using the associated DMRS carried in the PBCH 406 and/or 410. The PBCH 406 and/or 410 may include the master information block (MIB) part of the MAC layer broadcast channel (BCH). The other part of the BCH, such as the system information block (SIB), may be included in a PDSCH allocation encoded with the system information-radio network temporary identifier (SI-RNTI).

During an initial cell search or a cell reselection, a UE searching for a cell may use a sliding window and correlation technique to look for the PSS 404. For example, the UE may use a sliding window with a length of one (1) symbol to try to correlate one or more possible PSS sequences as the UE may not know which SCs are used by the PSS 404. In addition, due to the Doppler, internal clock frequency shifts, and/or other frequency errors associated with the PSS 404, the UE may use a different timing hypothesis and/or frequency hypothesis to account for these errors. For example, for each timing hypothesis, the UE may try to use all three sequences+N frequency hypotheses to account for the Doppler, internal clock frequency shifts, and any other frequency errors, etc.

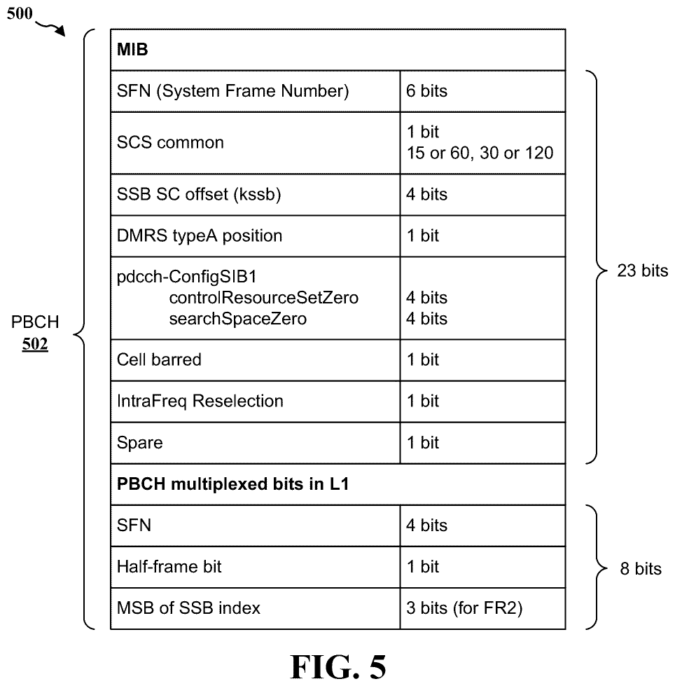

In some examples, based on the PSS 404 and/or the SSS 408, the UE may know the timing and/or frequency of the PBCH 406 and 410 (collectively as the PBCH) within the SSB 402. The PBCH may include 576 resource elements (REs) (e.g., 1 RE=1 SC×1 symbol), where 576 REs=240×2 (at symbols one and three)+ (48+48) (at symbols two)=number of REs. The PBCH may carry the MIB and DMRS, and the PBCH may be modulated with QPSK. The UE may perform coherent demodulation of the PBCH based on the DMRS carried in the PBCH. In addition, the UE may use the DMRS to perform channel estimation. In one example, the DMRS may carry, or be used by the UE to determine, three (3) least significant bits (LSB) (e.g., for the FR2) of an SSB index per half frame from a DMRS sequence index. For example, under the FR2, a base station or one or more transmission reception points (TRPs) of a base station may communicate with a UE using more than one beam (e.g., up to 64 beams), where each beam may correspond to one beam index. In some examples, each beam index may further be associated with an SSB index, such that the base station may indicate to the UE which beam(s) may be used by the base station for transmission through the SSB index. As a base station or TRP(s) of a base station may use up to 64 beams, the SSB index may be six (6) bits long (e.g., 26=64), where three (3) bits may be carried in the DMRS, and the other three bits may be multiplexed with the PBCH (e.g., as shown by “MSB of SSB index” within FIG. 5). In some examples, the DMRS may be interleaved (e.g., in frequency) with the PBCH data at every 4th SC (e.g., RE), such that the DMRS may include 144 REs (e.g., 60×2+12+12). The UE may use the DMRS, the SSS (e.g., 508) and/or the PSS (e.g., 504) signals in an SSB (e.g., 502) to refine the frequency offset estimation.

FIG. 5 is a diagram 500 illustrating an example of information that may be included in a PBCH of an SSB in accordance with various aspects of the present disclosure. A PBCH 502 may be thirty-one (31) bits long, such as for a network operating within the FR2, and the PBCH 502 may include one or more parameters that may be used by a UE to decode a system information block type one (SIB1) message (e.g., SIB1 PDSCH). For example, the MIB within the PBCH 502 may carry a pdcch-ConfigSIB1 field that includes a parameter for an initial CORESET (e.g., a controlResourceSetZero parameter) and a parameter for an initial search space set (e.g., a searchSpaceZero parameter). The controlResourceSetZero parameter may guide the UE to a CORESET0, where the CORESET0 may carry a PDCCH that has information for scheduling an SIB1 PDSCH. For example, the controlResourceSetZero parameter may be four (4) bits long, and the UE may use this parameter to determine a multiplexing pattern (discussed below) and the CORESET0's frequency offset, number of resource blocks (RBs) and/or number of symbols, etc. The searchSpaceZero parameter may be four (4) bits long, and the UE may use this parameter to determine the CORESET0's time location. Thus, based on the information included in the controlResourceSetZero parameter and/or the searchSpaceZero parameter, the UE may identify or determine the location (e.g., in time and/or frequency) of the CORESET0.

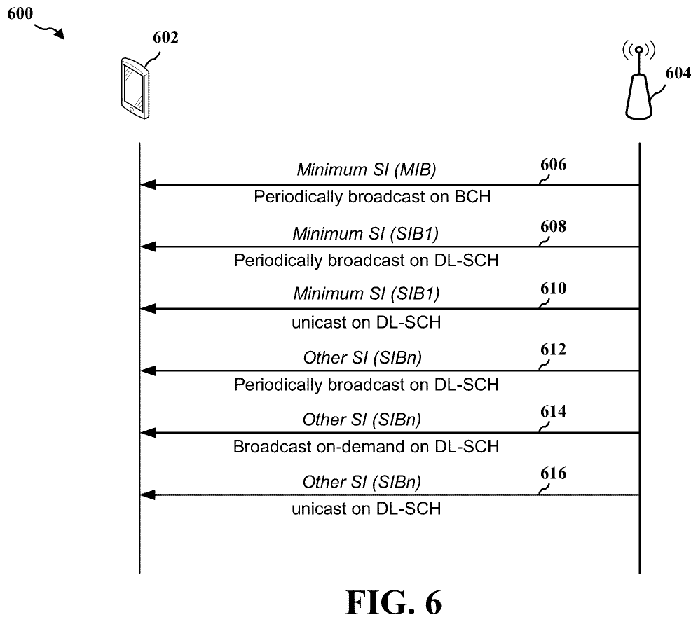

As described in connection with FIGS. 2B and 4, system information (SI) (e.g., the PBCH) may include a MIB and a number of SIBs. FIG. 6 is a communication flow 600 illustrating example SIB transmissions in accordance with various aspects of the present disclosure. As shown by the communication flow 600, the system information may be divided into multiple minimum SI (e.g., 606, 608, 610) and other SI (e.g., 612, 614, 616). The minimum SI (e.g., 606, 608, 610) may include basic information for a UE 602's initial access to a cell 604 (e.g., base station) and information for acquiring any other system information. For example, minimum SI may include a MIB 606, which may contain cell barred status information and physical layer information of the cell 604 for receiving further system information (e.g., CORESET #0 configuration). The cell 604 may broadcast the MIB 606 periodically on a broadcast channel (BCH). The minimum SI may also include an SIB1 (e.g., 608 and/or 610), where the SIB1 may define the scheduling of other system information blocks and may contain information for the UE's initial access to a base station, such as the random access parameters. For examples, the SIB1 may include information regarding the availability and scheduling of other SIBs (e.g., mapping of SIBs to SI message, periodicity, SI-window size, etc.). The SIB1 may also indicate whether one or more SIBs is provided based on on-demand, in which case, it may also provide physical random access channel (PRACH) configuration for the UE to request for the SI. PRACH may be an uplink channel used by a UE for connection request purpose, such as used by the UE to carry the RACH transport channel data. The SIB1 may further contain RRC information that is common for all UEs and cell barring information applied to the unified access control. The SIB1 (e.g., 608 and/or 610) may be referred to as the remaining minimum SI (RMSI), which may be periodically broadcasted by the cell 604 on a downlink-share channel (DL-SCH) (e.g., using SIB1 608) or transmitted to a dedicated UE (e.g., RRC connected) on the DL-SCH (e.g., using SIB1 610). The other SI (e.g., SIBn 612, 614, 616) may include other SIBs not being broadcasted in the minimum SI (e.g., 606, 608, 610). The other SI may be periodically broadcasted by the cell 604 on the DL-SCH, broadcasted on-demand on the DL-SCH (e.g., requested by the UE 602), or transmitted in a dedicated manner on the DL-SCH to one or more UEs including the UE 602. For example, SIB2 may include cell re-selection information, SIB3 may include information about the serving frequency and intra-frequency of the neighboring cells relevant for cell re-selection, etc.

In order for a UE to initiate a RACH procedure with a base station, the base station may be configured to continuously broadcast SSBs (e.g., the SSB 402) at a defined periodicity. For example, a base station may support SSB periodicities of 5, 10, 20, 40, 80, and/or 160 ms, and the number of SSB occasions within an SSB burst set may be configurable based on a bitmap. In some examples, during a cell search, a UE may be configured to assume the (default) periodicity of an SSB burst set as 20 ms (e.g., 2 frames), but the actual periodicity may be up to network implementation (e.g., 5, 10, 20, 40, 80, and/or 160 ms configurable by SIB1).

An SSB burst set may refer to a set of SSBs transmitted in a defined period, and the number of SSB occasions (beams) configured for an SSB burst set may be fixed over each periodicity. In addition, an SSB burst set may be associated with beam sweeping, where different SSBs in an SSB burst set may be transmitted on different transmission beams to cover an entire cell. For example, an SSB burst set may include a set of eight SSBs that are configured to be transmitted via eight SSB beams of a base station within 5 ms (e.g., a half frame) based on beam sweeping. In some examples, the maximum number of SSBs (“Lmax”) that may be configured for an SSB burst set (or beam directions for beam sweeping) may depend on the corresponding carrier frequency. For example, an SSB burst set may have a maximum number of 4 SSBs configured in the first 2 slots when the carrier frequency is less than or equal to 3 GHz (e.g., carrier frequency≤3 GHz, Lmax=4), whereas an SSB burst set may have a maximum number of 8 SSBs configured in the first 4 slots when the carrier frequency is under FR1 and is greater than or equal to 3 GHz (e.g., FR1 carrier frequency ≥3 GHz, Lmax=8), etc. In another example, when the carrier frequency is under FR2 (e.g., for mmW), an SSB burst set may have a maximum number of 64 SSBs. In other words, for FR1, a maximum of 4 or 8 different beams may be used for beam sweeping, and for FR2, a maximum of 64 different beams may be used for beam sweeping, etc.

In summary, an SSB may consist of several signals/components (e.g., PSS, SSS, and PBCH, etc.). A list of SSBs transmitted on different half slots that are confined to a predefined time window duration (e.g., 5 ms) may compose an SSB burst. Each SSB from an SSB burst may be associated/transmitted with a different Tx beam out of a list of Tx beams that is used by a base station (or a component of a base station) to sweep/cover an entire cell range (e.g., a beam sweeping is performed over SSB). SSB bursts may be transmitted in a periodic way with one of the SSB periodicities (e.g., 5, 10, 20, 40, 80, 160 ms, etc.).

SSB transmitted from a cell may be used by UEs in a cell coverage range for multiple purposes. In one example, the SSB may be used by UEs for an initial acquisition procedure, where UEs may discover the cell and camp/connect to the cell based on the received/detected SSB. Initial acquisition on UE side may also include operational SSB beam search as a part of the initial detection procedure. In another example, the SSB may be used for UE (Rx) and/or base station (Tx) beam tracking. As SSB may typically be used as a basis for P1 beam management (serving beam tracking) and best alternative/SSB beams identification and reporting to the network (e.g., SSB based beam management report). For purposes of the present disclosure, P1, P2, and P3 may refer to a set of processes that are designed for beam management while a UE is in a connected state. In another example, the SSB may be used for UE Rx beam tracking, where the SSB may be used for UE beam selection and tracking per SSB beam or relevant subset of SSB beams (e.g., typical proprietary implementation of SSB based P3 beam management). In another example, the SSB may enable automatic gain control (AGC) tracking per SSB beam or relevant subset of SSB beams. In another example, SSB resources may be used as a basis for beam failure detection (BFD), beam failure recovery (BFR), and/or radio link monitoring/failure detection (RLM/RLF) procedures. In another example, the SSB may be used for synchronization loops maintenance. For example, a serving SSB may be used by a UE to maintain a continuous time and frequency synchronization with a network (in some scenarios SSB may be used as the primary synchronization signal instead of tracking reference signal (TRS)). In another example, the SSB may be used for maintaining serving cell and neighboring cell measurements to support mobility and hand over procedure between cells.

In most of scenarios, how SSB IDs are related/mapped to a list of physical Tx beams used by a base station or component(s) of the base station to sweep an entire cell space and/or spatial range may not be known to UEs. As a result, a UE may not have any side information related to SSB IDs correspondence to physical beams, physical beams sweeping implementation, or any assumption regarding a linkage or correlation between different SSB IDs (e.g., which SSB IDs sweep along azimuth/elevation dimensions, which SSB IDs correspond to neighboring spatial beams, etc.). For example, in some network implementations, SSB IDs and physical beams mapping may be arbitrary and up to base station/network implementation. As such, a UE may be specified to maintain basically a fully blind search/tracking of SSB beam(s). In other words, the UE may strongly rely on any down selection of SSB IDs and/or resources based on network configuration (e.g., SSB based BM report/resources, BFD/RLM/RLF resources, and/or BFR resources, etc.).

Aspects presented herein may improve multiple beam management and neighbor cells monitoring related characteristics on a UE side including improved power consumption, configuration volume reduction, more robust and efficient beams tracking procedures for UEs monitoring and receiving SSBs transmitted by a base station or component(s) of a base station employing a systematic and semi-deterministic SSB beam sweeping pattern from UE's perspective. For example, one or more systematic beam sweeping patterns and/or directions may be used and several related parameters defining two-dimensional (2D) beam sweep patterns may be indicated to a UE. Aspects presented herein may provide enhanced beam management procedures and neighboring cell measurement procedures from a UE's perspective at least with a reduced UE power and potentially longer UE sleep time durations. In addition, aspects presented herein may enable a UE to take a more active role in overall beam management (BM) processes, such as BFD, RLM, and/or BFR procedures for the communication link between the UE and the network (e.g., a UE is typically in a “slave” mode while a network is in a “master” mode for BM of the communication link in most network implementations). This in turn may enable RRC configuration volume and RRC reconfiguration rates to be reduced for a UE, and provide a more robust beam tracking and BFR.

A beam management or a beam selection that is based on a base station performing a beam sweeping and a UE selecting a best beam and reporting the best beam to the base station may be referred to as a P1 beam management or P1 BM. P1 BM is typically done based on SSB resources. For example, a list of SSB IDs may be RRC configured for a UE for SSB-based BM reporting (e.g., CSI report with reportQuantity=ssb-Index-RSRP). Correspondingly, all of the configured resources and/or SSB beams are to be measured by the UE for determination of this BM report. In some examples, the UE may report up to four (4) best SSB beams/SSB IDs, and the maximum number of best beams/SSB IDs that can be reported by the UE may depend on the UE capability. Based at least in part on the P1 BM report provided by the UE, the network (or the corresponding base station) may determine one or more candidate beams for beam refinement procedure (P2) and BFD, RLF, and/or BFR resources/beams to be configured for the UE.

The list of the best SSB beams, which may include a serving SSB beam and several alternative SSB beams, may change dynamically based on the UE and its environment related mobility. If a relatively small number of SSB resources is configured by a network to a UE for P1 BM reporting, then RRC reconfiguration of SSB IDs for SSB based BM report may be specified for the UE. RRC reconfiguration may be a nonsynchronous procedure that involves a relatively high latency (e.g., hundreds of microseconds (ms)) and, practically, RRC reconfigurations may not be done “on the fly”. As such, a network may enable all SSB IDs (e.g., up to 64 for FR2) to be configured for P1 BM reporting.

Given the lack of any knowledge on the UE side regarding SSB IDs to physical Tx beams mapping, a UE that receives such a configuration (e.g., the RRC configuration) may be specified to measure all of the configured SSB resources all the time. This may specify an increased power consumption on the UE side for BM related processing. In addition, measurement of an SSB beam/SSB ID on the UE side may also specify continuous UE beam tracking (e.g., UE candidate beam(s) testing) for the corresponding SSB beam/SSB ID which may increase the effective rate of the specified processing per SSB beam/SSB ID. In some examples, the maximum rate may be limited by the SSB periodicity, but the minimum rate may be up to the UE's implementation and is supposed to be correlated to the UE mobility and signal-to-noise-ratio (SNR). Also, higher rate of SSB related measurements with a more numerous list of SSB IDs to be measured may also disrupt and/or limit a UE's sleep duration, which may be another factor for the increased UE power consumption. As SSB is an “always on” signal (e.g., continuously transmitted by a base station), the power consumption related to the SSB processing may be significant.

Examples above illustrate an existing trade-off between RRC configuration volume and related processing specification and power consumption aspects on the UE side and a potential problem for RRC reconfigurations in the real time regime. Typically, avoidance and/or minimization of RRC reconfigurations may be the prioritized consideration.

In some scenarios, in case of numerous SSB resources are configured to a UE for P1 BM reporting, the UE may typically be specified to perform certain down selection and/or prioritization of SSB resources to be measured for every SSB burst for the sake of power reduction, thermal aspects, and/or other considerations. In some examples, this down selection and/or prioritization may be done just based on the history of SSB measurements or based on some BFD/RLM/BFR configuration related linkages. However, these types of operation/beam management related procedures on the UE side may have a limited effectiveness, a limited responsiveness of optimal Tx beam tracking, a limited robustness, and may also be a limiting factor for UE mobility and BFD/BFR responsiveness.

As such, to simplify and enhance different aspects of serving and candidate SSB beams tracking procedures from a UE's perspective, SSB IDs ordering (e.g., sweep pattern) should be configured to be deterministic from the UE's perspective, such that a UE may be able to effectively classify SSB IDs and prioritize beam tracking and/or beam search for a subset of SSB IDs based on an algorithm that is capable of discovering the nearest beam(s) related to one or more last known best beams or a more relevant beams list with a minimized rate of measurements across all SSB IDs and/or without specifying a full repetitive search over all the configured/relevant SSB IDs for BM.

In some examples, SSB resources may be used as a basis for BFD, RLM, RLF, and/or BFR procedures where a list of SSB IDs may be RRC configured for BFD, RLM, RLF, and/or BFR separately. Similarly, the trade-off between the RRC configuration volume and related processing specifications and power consumption aspects on the UE side and a potential problem for RRC reconfigurations for real time regime described above may also be applicable in the context of BFD, RLM, RLF, and/or contention-free random access (CFRA) based BFR. To be able to avoid RRC reconfigurations, some network may enable up to 64 resources for CFRA based BFR to be configured for a UE (e.g., potentially covering all SSB beams). In some examples, in the case of BFD, RLM, and/or BFR, there may also be different limitations for the maximum number of configurable SSB/CSI-RS resources for different procedures depending on UE capabilities. Even with a maximum UE capability envelope, some of the configurations may still be limited, such as by the network or by a standard (e.g., a maximum of ten (10) resources for BFD, RLM, and/or RLF).

Aspects presented herein may provide one or more semi-deterministic SSB beam sweeping patterns that may enable a UE to effectively down select and/or prioritize more relevant candidate SSB beams/IDs. This in turn may enable the UE to take a more active role in BM related procedures without a strong dependence on RRC configurations and/or reconfigurations provided by the network. In other words, aspects presented herein may enable a UE to be more autonomous in BFD, RLM and/or BFR SSB resources selection/tracking which can be done dynamically and without any or with minimal assistance from the network. Thus, RRC configuration volume may be reduced and RRC reconfigurations related to these procedures may also be eliminated.

For example, RRC configuration for BFD, RLM and/or BFR related SSB resources from the network side may make sense in the case that that the configuration is being figured out on the network side autonomously and is not based on any UE reporting (e.g., otherwise the UE may opportunistically “configure itself” based on the same information). Thus, lack of any insight regarding the linkage between beams sweeping pattern and SSB IDs is one of the primary reasons for superiority on the network side in relation to SSB based beam management procedures for the link. Aspects presented herein may significantly reduce BM related advantages on the network side and may enable a more autonomous and robust beam management on the UE side. Also, besides the complete information regarding beams characteristics and beam sweeping pattern, the network side may also rely on ray tracing assisted by UE location information/positioning, beam reporting history from different UEs in the cell per location, different sensors fusion for enhanced beam management, etc.

In some examples, intermediate approach may also be to configure to a list of anchor SSB beams (coupled to the proposed beams sweeping pattern as will be elaborated further) and a UE may be autonomously account for all the neighboring beams around them for any BFD, RLM, RLF, and/or BFR procedures (which may assume BFR based on CBRA as a complementary option). Aspects presented herein may provide additional or another way to reduce RRC reconfiguration volume and a potentially specified RRC reconfigurations rate. In some examples, BFR recovery procedure may be based on CFRA RACH or contention-based random access (CBRA) RACH. CFRA may specify corresponding dedicated configurations (e.g., dedicated RACH preambles, RACH resources and/or BFR CORESETs per candidate BFR beam) and this part of the network side functionality may not be eliminated or replaced some way from the UE side. However, CFRA for BFR may be an additional configuration since there is a fallback option for CBRA for BFR in case that CFRA is not configured to a UE or does not cover the relevant SSB beam.

Aspects presented herein may enable a UE to take a more active and autonomous role in beam management for the communication link between the UE and a base station, and may also enable the UE to be less dependent on network configurations. As communication based on sub-THz band (e.g., 90 GHz to 300 GHz) may become more operational moving forward, aspects presented herein may be suitable for sub-THz communications. For example, coverage is expected to be one of the main challenges for sub-THz band as limited power amplifier (PA) efficiency is anticipated for such a high frequencies communication in addition to a more limited maximum PA output power and a higher pathloss of the communication link.

In order to overcome coverage related limitations, more antenna elements may be specified (e.g., a larger antenna array size) for a wireless device which may result in narrower beams. Correspondingly, significantly higher number of SSB beams may be specified to provide spatial cell coverage for sub-THz band. Number of SSB beams and ability to control beam width may also depend on beamformer implementation and architecture related constraints (e.g., lensed MIMO/beamformer, Butler Matrix beamformer, and other beamformer architectures that are considered for sub-THz). With a higher number of SSB beams, a UE's ability for a more efficient and autonomous SSB beams prioritization and/or down selection and tracking may have higher importance. In addition, a lower number of UEs may be expected to be served by a sub-THz cell in general (e.g., smaller cell size compared to other bands) and per sub-THz SSB beam specifically (e.g., a narrower beam). This may downgrade the importance of CFRA for sub-THz. Sub-THz scenario with assumption of BFR that is based just on CBRA may support minimization of BFR related configurations (e.g., BFR beams/resources configuration may not be specified) with autonomous list of candidate beams maintenance on the UE side that can be achieved in a more efficient way based on aspects of the present disclosure (e.g., a systematic semi deterministic SSB beam sweeping pattern).

Additional aspects that are anticipated for the sub-THz band may be related to UE power and thermal considerations. Power saving techniques may become an important criterion for designing sub-THz wireless devices. Potential UE power savings that can be achieved with a more efficient BM procedure on the UE side that can be enabled by aspects presented herein may be especially useful in the context of sub-THz. Also, in the case of 6G/sub-THz scenario, there may be less issue of some potential backward compatibility (e.g., for SSB beam sweep implementation on the network side) or some limitations for adding aspects of the present disclosure to the existing deployments. In case of existing deployments (e.g., FR2), for some older UEs, aspects of the present disclosure may be transparent, and any aspect related to beam management for these UEs may remain unchanged. In other words, aspects presented herein may be configured to apply just to “new” and/or capable UEs that will be able to take advantage of semi-deterministic and/or “known” SSB IDs to physical beams mapping structure/pattern.

In one aspect of the present disclosure, a base station or component(s) of the base station (e.g., the transmitter, antenna, etc.) may be configured to perform beam sweeping based on a two-dimensional systematic mapping between SSB IDs and physical SSB beams (e.g., over azimuth and elevation dimensions), such that the base station may perform SSB beam sweeping with SSB index/ID linked to SSB beams over 2D beams map in a systematic and predefined way. In addition, the SSB beam sweep parameters may be configured for a UE, or partially pre-defined (e.g., based on a standard or rule) and partially configured for the UE to provide customization per cell or deployment.

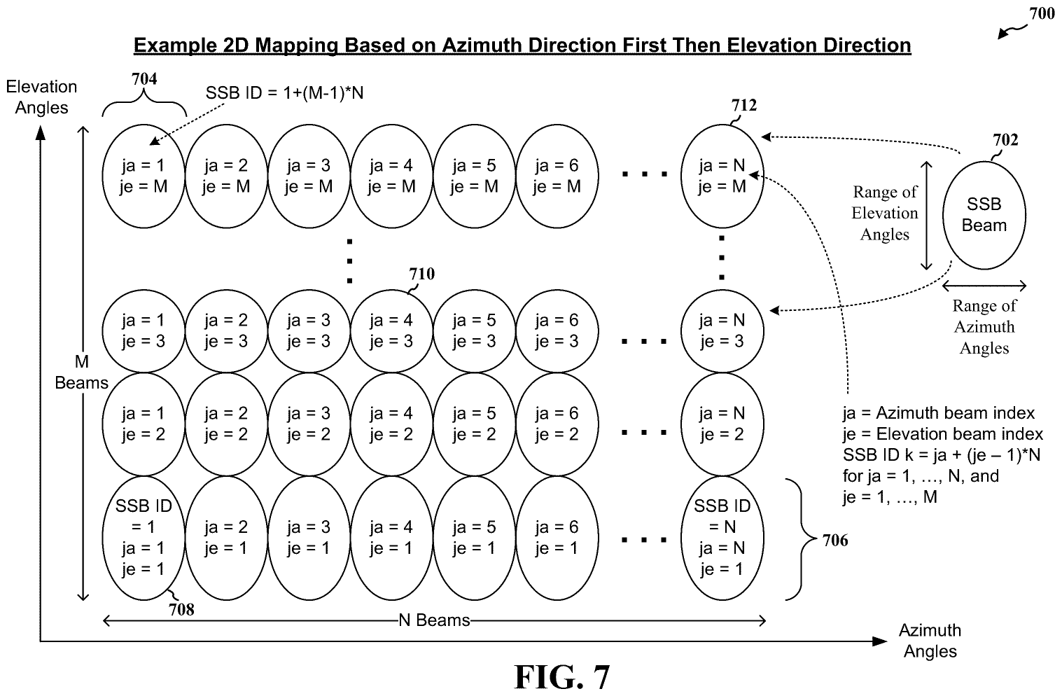

FIG. 7 is a diagram 700 illustrating an example 2D mapping/2D indexing of SSB beams based on azimuth and elevation angles in accordance with various aspects of the present disclosure. In one example, a base station or a transmitting component of the base station may be configured to transmit N beams over the azimuth dimension (or angles) and M beams over the elevation dimension (or angles). Thus, the base station may transmit a total of K=N·M SSB beams 702 in a spatial dimension. For example, a base station may be configured to transmit 10 SSB beams over the azimuth dimension and 5 SSB beams over the elevation dimension, resulting in a total of 50 SSB beams that may cover an entire spatial dimension.

In one aspect, each SSB beam in the SSB beams 702 may be configured to cover a range of azimuth angles or a range of elevation angles that is different from another SSB beam in the SSB beams 702 based on a 2D mapping, and each SSB may be associated with a first index in the azimuth direction (denoted as jₐ) and a second index in the elevation direction (denoted as jₑ). As such, for N beams in the azimuth direction, jₐ=1, 2, 3, . . . , N, and for M beams in the elevation direction, jₑ=1, 2, 3, . . . , M, etc. For example, as shown at 704, different SSB beams 702 with the same range of azimuth angles (e.g., SSB beams with elevation index (jₑ)=1, 2, 3, . . . , M and azimuth index (jₐ)=1) may cover different ranges of elevation angles (which may not overlap with each other) based on the 2D mapping. Similarly, as shown at 706, different SSB beams 702 with the same range of elevation angles (e.g., SSB beams with azimuth index (jₐ)=1, 2, 3, . . . , N and elevation index (jₑ)=1) may cover different ranges of azimuth angles (which may not overlap with each other) based on the 2D mapping. Then, based at least in part on the 2D mapping, a set of SSB IDs/indexes may be assigned to the SSB beams using a predefined systematic mapping or a corresponding predefined mapping rule. For example, for azimuth first then elevation mapping approach, for K=N·M SSB beams 702, an SSB ID k may be assigned to each of the SSB beams 702 based on k=jₐ+(jₑ−1) N for jₐ=1, . . . , N, jₑ=1, . . . , M. Thus, if N=10 and M=5, as shown at 708, an SSB beam with azimuth index jₐ=1 and elevation index jₑ=1 may be assigned with an SSB index=1 as 1+(1−1)*10=1. As shown at 710, an SSB beam with azimuth index jₐ=4 and elevation index jₑ=3 may be assigned with an SSB index=24 as 4+(3−1)*10=24. As shown at 712, an SSB beam with azimuth index jₐ=10 and elevation index jₑ=5 may be assigned with an SSB index=50 as 10+(5−1)*10=50.

Based on the 2D mapping, if the SSB ID for an SSB beam is known, the corresponding jₐ and jₑ may also be derived from the SSB ID to locate the corresponding SSB beam based on jₐ=mod(k, N) and jₑ=└k/N┘+1. For example, if N=10 and M=5, for SSB ID k=24, jₐ=mod(k, N)=mod(24, 10)=4, and jₑ=└k/N┘+1=└24/10┘+1=3.

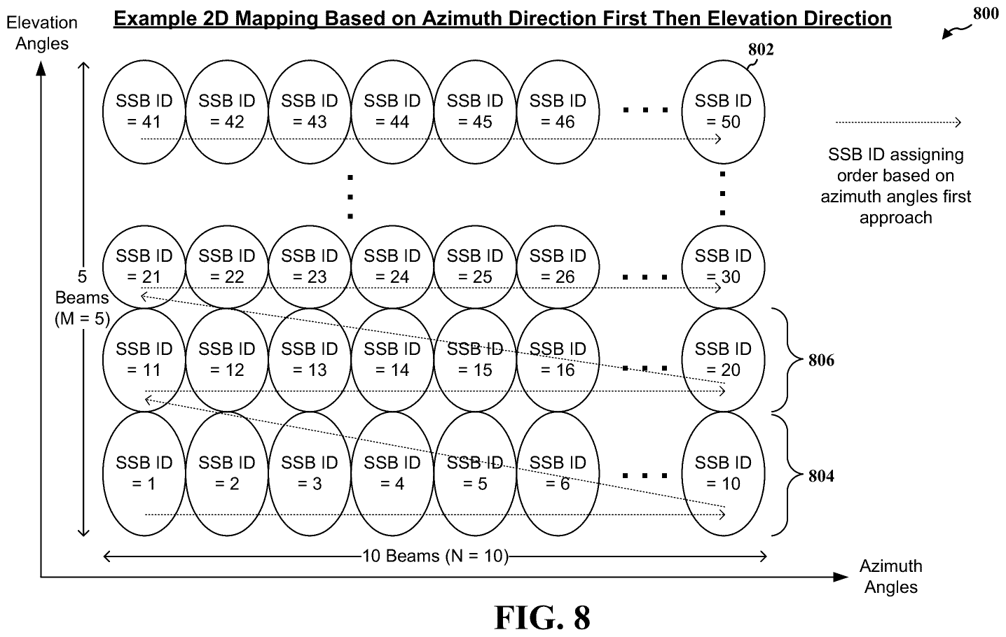

FIG. 8 is a diagram 800 illustrating an example mapping of SSB IDs over a 2D map of SSB beams based on the azimuth angles first and then the elevation angles (azimuth first, elevation second mapping) in accordance with various aspects of the present disclosure. As shown by the diagram 800, a base station that is configured to transmit 10 SSB beams over the azimuth dimension and 5 SSB beams over the elevation dimension (e.g., resulting in a total of 50 SSB beams 802) may assign an SSB ID to each of the SSB beams 802 based on an azimuth angles first and then the elevation angles approach. For example, as shown at 804, for SSB beams starting with the lowest elevation index (jₑ)jₑ (e.g., jₑ=1 which corresponds to the lowest elevation index/angle option), an SSB index may be assigned to these SSB beams based on their azimuth index (jₐ) or consecutively over azimuth direction, such that SSB ID=1 may be assigned to the SSB beam with jₑ=1 and jₐ=1, . . . , SSB ID=10 may be assigned to the SSB beam with jₑ=1 and jₐ=10, etc., until all SSB beams with jₑ=1 are each assigned with an SSB ID. Then, as shown at 806, after each of the SSB beams with jₑ=1 are assigned with an SSB ID, for SSB beams starting with the next lowest elevation index (jₑ) (e.g., jₑ=2), an SSB index may continue to be similarly assigned to these SSB beams based on their azimuth indexes/values, such that SSB ID=11 may be assigned to the SSB beam with jₑ=2 and jₐ=1, . . . , SSB ID=20 may be assigned to the SSB beam with jₑ=2 and jₐ=10, etc., until all SSB beams with jₑ=2 are assigned with an SSB ID. The process may continue until all SSB beams are assigned with the corresponding systematically determined SSB ID based on the 2D mapping (in this case azimuth first, elevation second SSB IDs to physical SSB beams mapping). Alternative, the SSB IDs may also be assigned to the SSB beams based on the elevation angles first approach (elevation first, azimuth second SSB IDs to physical SSB beams mapping).

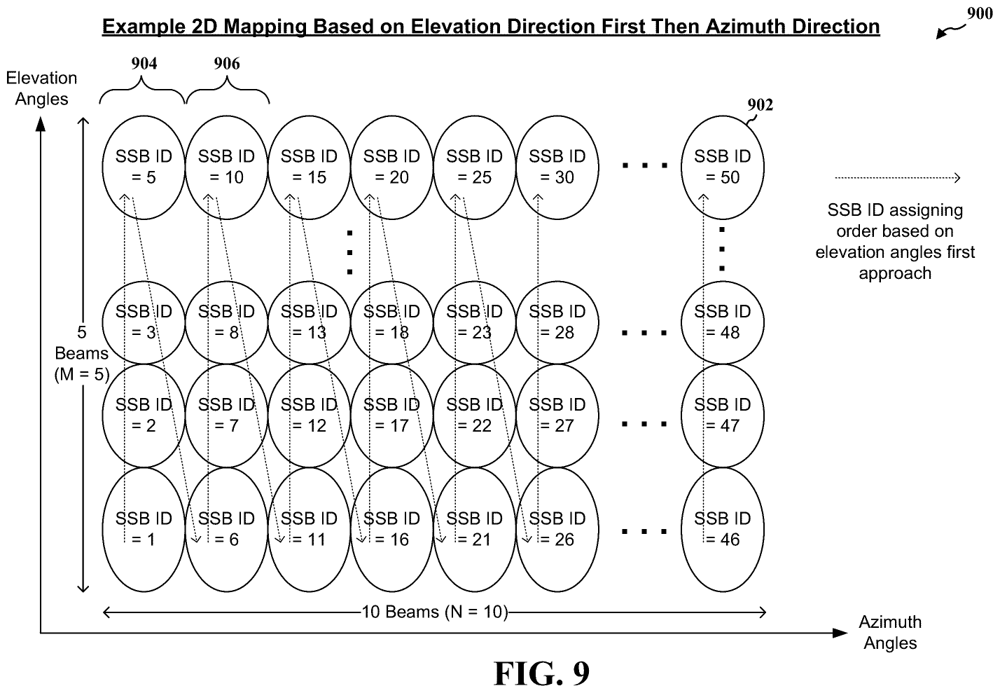

FIG. 9 is a diagram 900 illustrating an example mapping of SSB IDs over 2D map of SSB beams based on the elevation angles first and then the azimuth angles (elevation first, azimuth second mapping) in accordance with various aspects of the present disclosure. As shown by the diagram 900, a base station that is configured to transmit 10 SSB beams over the azimuth dimension and 5 SSB beams over the elevation dimension (e.g., resulting in a total of 50 SSB beams 902) may assign an SSB ID to each of the SSB beams 902 based on an elevation angles first and then the azimuth angles approach. For example, as shown at 904, for SSB beams starting with the lowest azimuth angle/index (jₐ) (e.g., jₐ=1), an SSB index may be assigned to these SSB beams based on their elevation index (jₑ) or consecutively over elevation direction, such that SSB ID=1 may be assigned to the SSB beam with jₐ=1 and jₑ=1, SSB ID=5 may be assigned to the SSB beam with jₐ=1 and jₑ=5, etc., until all SSB beams with jₐ=1 are each assigned with the corresponding systematically determined SSB IDs based on the 2D mapping (in this case elevation first, azimuth second SSB IDs to physical SSB beams mapping). Then, as shown at 906, after each of the SSB beams with jₐ=1 is assigned with the corresponding SSB ID, for SSB beams starting with the next lowest azimuth index (jₐ) (e.g., jₐ=2), an SSB index may continue to be similarly assigned to these SSB beams based on their elevation indexes/values, such that SSB ID=6 may be assigned to the SSB beam with jₐ=2 and jₑ=1, . . . , SSB ID=10 may be assigned to the SSB beam with jₐ=2 and jₑ=5, etc., until all SSB beams with jₐ=2 are assigned with a corresponding SSB ID. The process may continue until all SSB beams are assigned with one SSB ID.

By mapping SSB IDs to SSB beams based on their elevation angles and azimuth angles, a UE may classify SSB beams into different categories (neighboring, spatially close, spatially distant) if the UE is configured with or is aware of the mapping (i.e., the corresponding transmitting dimensions of the SSB IDs/beams) and based on the classification may measure SSB beams more efficiently (with some prioritization/de-prioritization). For example, referring back to FIG. 8, if a UE is communicating with a base station via a serving SSB beam that corresponds to SSB ID=15, the UE may prioritize measurements for candidate beams that are in proximity to the serving SSB beams. For example, the UE may prioritize measurements for SSB beams that are directly adjacent to the serving SSB beam, such as SSB beams that correspond to SSB IDs 5, 14, 16, and 25. Similarly, referring back to FIG. 9, if a UE is communicating with a base station via a serving SSB beam that corresponds to SSB ID=12, the UE may prioritize measurements for candidate beams that are in proximity to the serving SSB beams. For example, the UE may prioritize measurements for SSB beams that are directly adjacent to the serving SSB beam, such as SSB beams that correspond to SSB IDs 7, 11, 13, and 17. As such, based at least in part on the mapping knowledge/side information, the UE may classify SSB IDs and efficiently prioritize and/or downsize its SSB beam/IDs measurements, such as by measuring most relevant SSB beams/IDs first before measuring other less relevant SSB beams/IDs (e.g., measuring SSB beams that are closer to the serving beam or a known best alternative beams before measuring SSB beams that are further away from the serving beam or some list of alternative beams).

In another aspect of the present disclosure, the 2D mapping of SSB beams (e.g., based on the azimuth range/dimension and the elevation range/dimension) described in connection with FIGS. 7 to 9 may further be subdivided into multiple non-overlapping 2D blocks of beams of a smaller size to enable a hierarchical beam sweeping pattern. As such, an SSB beam sweeping pattern may be subdivided into two levels: an inter block sweeping level and an intra block sweeping level. For example, each 2D block may include a set of SSB beams covering a range of azimuth angles and a range of elevation angles, and dimensions of the 2D block (in terms of the number of included neighboring beam(s)) over azimuth and elevation directions may be defined such that there may be N and M beam indexes in azimuth and elevation directions per block, respectively, (e.g., resulting in K=N·M confined in some azimuth and elevation range beams per block). These 2D block dimensions may be configured to be the same for multiple or all of the 2D blocks of beams. For purposes of the present disclosure, beam(s) blocking or neighboring beam(s) blocking may refer to a process of logical association or mapping different sets of SSB beams to different beam blocks (or simply blocks), such that different beam blocks may include different sets of SSB beams that cover different azimuth ranges and/or elevation ranges (described in more details below).

Neighboring beams blocking may be beneficial for a UE as the UE may generate a more localized beam search (e.g., within an SSB burst duration) around the candidate and serving SSB beams. For example, for most of times, beam blocking may provide a more localized time location for SSBs corresponding to neighboring beams. This may be beneficial from the point of view of UE sleep time management and inter cell coordination of mutual interference.

Additional advantage of beam blocking is to reduce signaling/configuration volume reduction when anchor SSBs indication/configuration (e.g., just SSB block indexes) is able to be provided for the UE (e.g., for BM reporting, BFD, BFR, RLM, and/or neighboring cell measurements) instead of a specific list of SSB IDs/beam indexes, such that the UE may limit its search locally within the indicated block(s) for candidate and serving SSB beams tracking. For example, indication of SSB beam blocks index instead of a list of specific SSB beams/IDs may specify less updating in case of some mobility and less configuration data in general (e.g., the number of SSB blocks may be lower than the overall number of SSB beams/IDs).

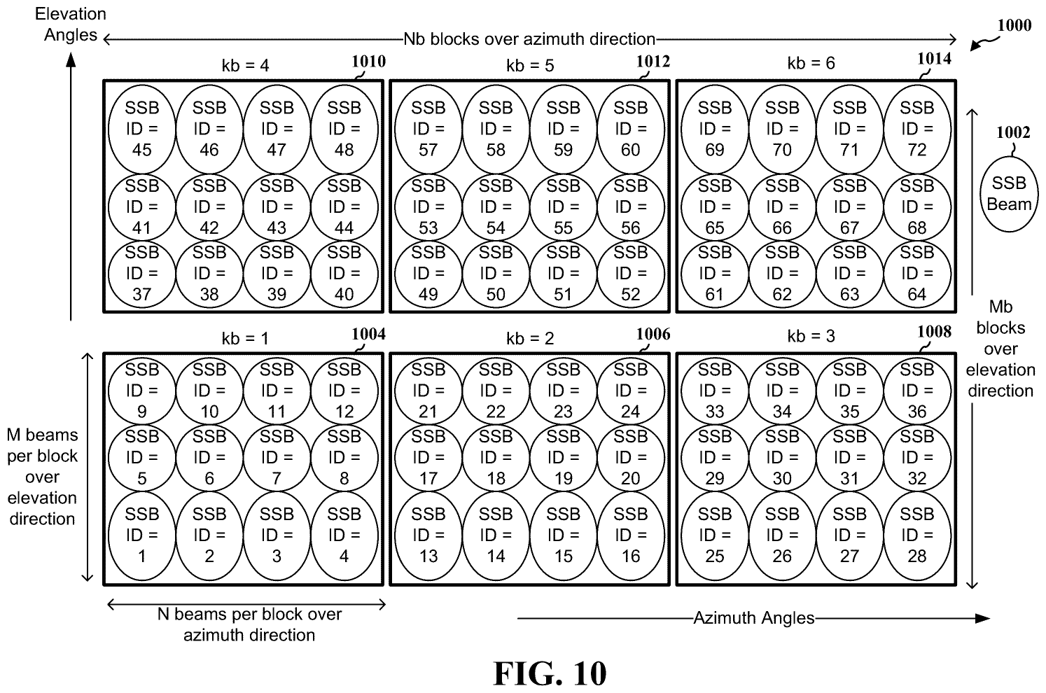

FIG. 10 is a diagram 1000 illustrating an example of beam blocking in accordance with various aspects of the present disclosure. A base station may be configured to transmit 12 SSB beams over the azimuth dimension (or direction) and 6 SSB beams over the elevation dimension (e.g., resulting in a total of 72 SSB beams 1002) that cover a spatial dimension for transmitting SSB. The SSB beams 1002 may further be subdivided into multiple beam blocks (K_{b}), where each beam block may include N SSB beams over the azimuth direction and M SSB beams over the elevation direction, resulting in K=N·M SSB beams per beam block. For example, as shown by the diagram 1000, the SSB beams 1002 may be subdivided into six (6) beam blocks 1004, 1006, 1008, 1010, 1012, and 1014 (e.g., corresponding to K_{b}=1, 2, 3, 4, 5, and 6), where each beam block may include for example four (4) SSB beams per azimuth direction (e.g., N=4) and three (3) SSB beams per elevation direction (e.g., M=3), such that each beam block may include 12 SSB beams (e.g., K=N·M=4·3=12). As described in connection with FIGS. 7 to 9, each SSB beam (or SSB ID) may cover a range of azimuth angles and a range of elevation angles. The degree of azimuth/elevation angles covered by different SSB beams may also be different. For example, the SSB beam that corresponds to SSB ID=1 may cover a wider elevation angles compared to the SSB beam that corresponds to SSB ID=5 or 9.

In one example, the base station may assign an SSB ID to each of the SSB beams 1002 based on two levels hierarchical mapping where the mapping is done intra block (e.g., beams indexing across azimuth (e.g., azimuth index jₐ) and elevation (e.g., elevation index jₑ) dimensions inside each beams block) and inter block (e.g., blocks indexes ordering/mapping across azimuth and elevation dimensions). The order of beam blocks may also be based on azimuth direction first and then the elevation direction approach (e.g., the azimuth first, elevation second mapping type). For example, the first three beam blocks on the bottom (lowest elevation range) may be assigned with k_{b}=1, 2, and 3, respectively, based on their azimuth direction, and the next three beam blocks on the top (at next/higher elevation values range) may also be assigned with k_{b}=4, 5, and 6, respectively, based on their azimuth direction. Then, for SSB beams in the first beam block 1004 (k_{b}=1), the mapping of SSB IDs may also be based on the azimuth angles first and then the elevation angles as described in connection with FIG. 8. In other words, for inter block mapping, the beam block index (k_{b}) for beam blocks 1, 2, 3, . . . , K_{b}, k_{b}=iₐ+(iₑ−1)N_{b}, for iₐ=1, . . . , N_{b}, iₑ=1, . . . , M_{b}, where iₐ is block index on azimuth direction, and iₑ is block index along elevation direction.

Thus, for SSB beams in the first beam block 1004 (k_{b}=1) which includes SSB beams having the lowest azimuth and elevation indexes referring to the full 2D map of beams as described in connection with FIG. 7, the intra block azimuth indexes (jₐ) (e.g., jₐ=1, . . . , N) and the intra block elevation indexes (jₑ) (e.g., jₑ=1, . . . , M) may be used similarly to what was provided in FIG. 7 (which was for single beam block/single mapping level example), and an SSB index may be assigned to these SSB beams (e.g. N*M beams of the first block) based on their jₐ and jₑ indexes/values following azimuth first and elevation second intra block mapping approach. Correspondingly SSB ID=1 may be assigned to the SSB beam with k_{b}=1, jₑ=1, and jₐ=1, . . . , SSB ID=4 may be assigned to the SSB beam with k_{b}=1, jₑ=1 and jₐ=4, etc., until all SSB beams with jₑ=1 in the first beam block 1004 (k_{b}=1) are each assigned with an SSB ID. Then, after each of the SSB beams with jₑ=1 in the first beam block 1004 are assigned with an SSB ID, for SSB beams starting with the next lowest jₑ (e.g., jₑ=2), an SSB index may continue to be similarly assigned to these SSB beams based on their jₐ values. For example, SSB ID=5 may be assigned to the SSB beam with k_{b}=1, jₑ=2 and jₐ=1, . . . , SSB ID=8 may be assigned to the SSB beam with k_{b}=1, jₑ=2 and jₐ=4, etc., until all SSB beams with jₑ=2 are assigned with the corresponding SSB ID. The process of the described intra block systematic mapping may continue until all SSB beams in the first beam block 1004 are assigned with an SSB ID.

Then, after all SSB beams in the first beam block 1004 are assigned with an SSB ID, similar mapping mechanism may also apply to the second beam block 1006 and the rest of beam blocks. For example, for SSB beams in the second beam block 1006 starting with the lowest jₑ (e.g., jₑ=1), an SSB index may be assigned to these SSB beams based on their jₐ values consecutively (intra block azimuth indexes for the second block), such that SSB ID=13 (e.g., continue from the last ID assigned in the first beam block 1004) may be assigned to the SSB beam with k_{b}=2, jₑ=1, and jₐ=1, SSB ID=16 may be assigned to the SSB beam with k_{b}=2, jₑ=1 and jₐ=4, etc., until all SSB beams with jₑ=1 in the second beam block 1006 are each assigned with an SSB ID. Then, after each of the SSB beams with jₑ=1 in the second beam block 1006 are assigned with an SSB ID, for SSB beams starting with the next lowest jₑ (e.g., jₑ=2), an SSB index may similarly be assigned to these SSB beams based on their jₐ values. For example, SSB ID=17 may be assigned to the SSB beam with k_{b}=2, jₑ=2 and jₐ=1, . . . , SSB ID=20 may be assigned to the SSB beam with k_{b}=2, jₑ=2 and jₐ=4, etc., until all SSB beams with jₑ=2 are assigned with an SSB ID. The process may continue until all SSB beams in all beam blocks are assigned with a corresponding SSB ID. Alternative, the SSB IDs may also be assigned to the SSB beams based on the elevation direction first and then azimuth direction approach for intra block beams mapping to SSB IDs, such as described in connection with FIG. 9.

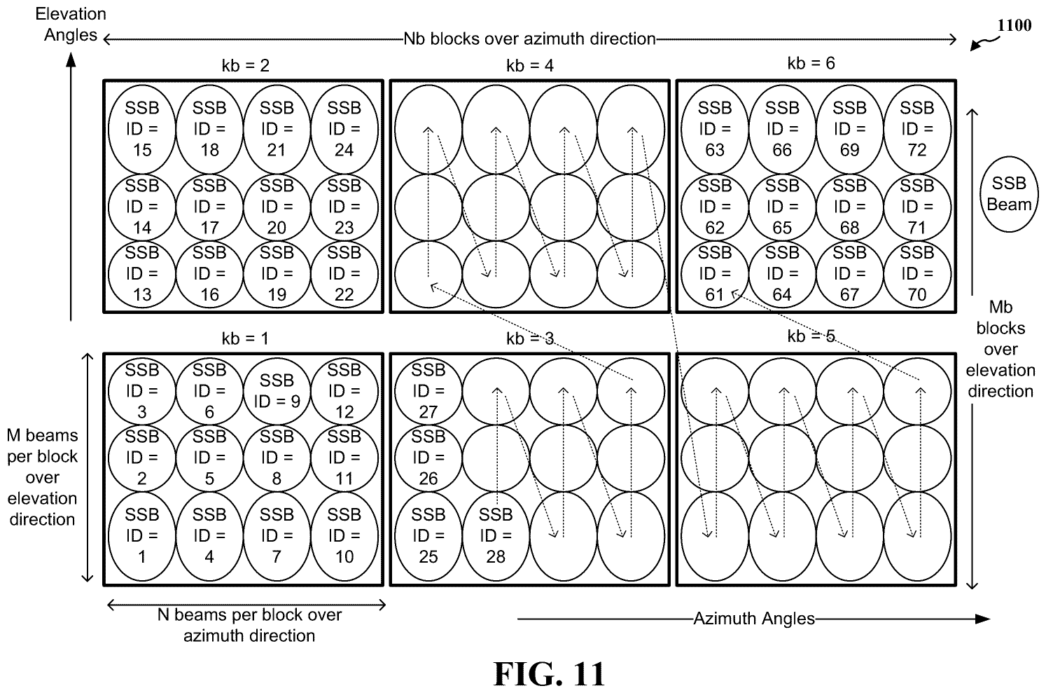

FIG. 11 is a diagram 1100 illustrating an example of beam blocking in accordance with various aspects of the present disclosure. In this additional example with two level beams to SSB IDs mapping hierarchy, the base station may use elevation direction first and azimuth direction second mapping/indexing for beam blocks (inter block mapping) and may assign an SSB ID to each of the SSB beams within each block (intra block mapping) based on an elevation direction first and then azimuth direction/angles mapping approach. For example, the first two beam blocks on the left (corresponding to the most left side/lowest azimuth angles range) may be assigned with k_{b}=1 and 2, respectively, based on their elevation direction, and the next two beam blocks in the middle (associated with the next azimuth angles range) may be assigned with k_{b}=3 and 4, respectively, based on their elevation angle direction/index, etc. Then, for SSB beams in the first beam block (k_{b}=1), the mapping of SSB IDs (intra block mapping) may also be based on the elevation angles first and then the azimuth angles as described in connection with FIG. 9. Thus, for SSB beams in the first beam block 1004 starting with the lowest jₐ (e.g., jₐ=1), an SSB index may be assigned to these SSB beams based on their jₑ values consecutively, such that SSB ID=1 may be assigned to the SSB beam with k_{b}=1, jₐ=1, and jₑ=1, . . . , SSB ID=3 may be assigned to the SSB beam with k_{b}=1, jₐ=1 and jₑ=3, etc., until all SSB beams with jₐ=1 in the first beam block are each assigned with a corresponding SSB ID. Then, after each of the SSB beams with jₐ=1 in the first beam block are assigned with the corresponding SSB ID, for SSB beams starting with the next lowest jₐ (e.g., jₐ=2), an SSB index may similarly be assigned to these SSB beams based on their jₑ values. For example, SSB ID=4 may be assigned to the SSB beam with k_{b}=1, jₐ=2 and jₑ=1, . . . , SSB ID=6 may be assigned to the SSB beam with k_{b}=1, jₐ=2 and jₑ=3, etc., until all SSB beams with jₐ=2 are assigned with an SSB ID. The process of systematic and predefined (elevation/azimuth first for intra/inter block level) mapping may continue until all SSB beams in the first beam block and the rest of the beam blocks are assigned with an SSB ID.

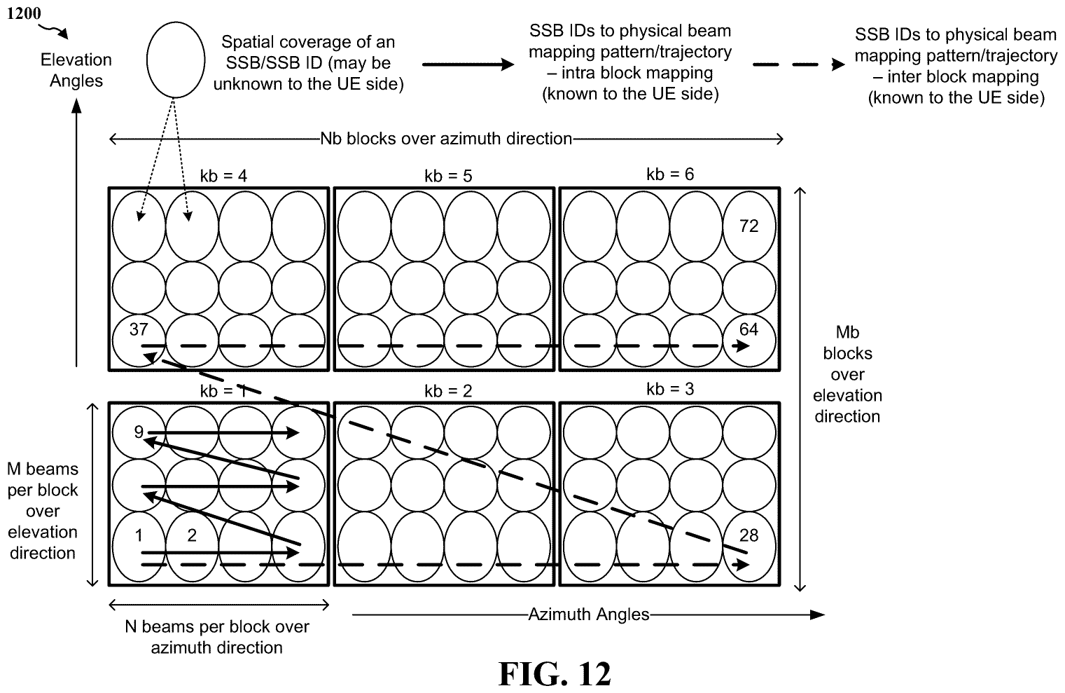

For the inter block sweeping, the beam blocks (e.g., the 2D SSB beam blocks) ordering may be based on azimuth direction first or elevation direction first as described by FIGS. 11 and 12, respectively. The order of the beam blocks mapping may be pre-defined by a specification/standard or configured for a UE. For purposes of the present disclosure and for the following examples, Nₚ and M_{b} may be used to denote the number of blocks per azimuth direction and elevation direction, respective, such that a total of K_{b}=N_{b}·M_{b} blocks may provide an entire (or a portion of) spatial cell coverage. Beams block index may be noted by k_{b}.

For the intra block sweeping, the SSB beams included in each beam block may be swept in azimuth direction first or elevation direction first as described by FIGS. 11 and 12, respectively. Similarly, the order of the beam blocks (azimuth or elevation direction first) may be pre-defined by a specification/standard or configured for a UE. For purposes of the present disclosure and for the following examples, the number of SSB beams covered per block over azimuth and elevations directions may be denoted by N and M, respectively, and beam index within a block may be denoted by k.

In one aspect, the overall SSB ID to beam index mapping will be defined as follows: SSB_{ID}=k+(k_{b}−1) K, while k=1, . . . , K; k_{b}=1, . . . , K_{b} and overall number of SSB beams/IDs is equal to K·K_{b}. Inverse relation may also be defined correspondingly: k_{b}=└SSB_{ID}/K┘+1 to map each SSB ID to a corresponding beams block index, and k=mod(SSB_{ID}, K) to map SSB ID to a specific beam index within a beam block, such as described in connection with FIGS. 10 and 11. This relation in conjunction with the mapping direction/trajectory for inter block and intra block mapping (k and k_{b} indexes determination across 2D map of SSB beams) may be sufficient for a UE to figure out SSB IDs corresponding to neighboring physical beams to localize/prioritize SSB search/measurements around the current list of serving and alternative beams (e.g., for neighboring beams category while other SSB IDs/beams may be deprioritized in overall beam management algorithm on the UE side to make it more power efficient). While examples described in connection with FIGS. 7 to 11 are based on either azimuth direction first or elevation direction first beam indexes and/or beams block indexes mapping (k, k_{b}), they are merely for illustrative purposes. Different combinations of azimuth direction first or elevation direction first may also be applied for the SSB beams and the beam blocks (e.g., for the inter and intra block mapping). For example, the mapping of beams in each beam block (e.g., the intra block mapping) may be based on azimuth direction first approach while the mapping of beam blocks (e.g., the inter block mapping) may be based elevation direction first approach, or vice versa.

FIG. 12 is a diagram 1200 illustrating an example of SSB ID to physical SSB beam mapping (sweep pattern) based on two levels of SSB beams sweeping in accordance with various aspects of the present disclosure. Similar to the example shown in FIG. 10, a base station may be configured to transmit 12 SSB beams over the azimuth dimension (or direction) and 6 SSB beams over the elevation dimension (e.g., resulting in a total of 72 SSB beams) that cover a spatial dimension for transmitting SSB. The SSB beams may further be subdivided into six beam blocks, such that N_{b}=3 (e.g., three beam blocks per azimuth direction), M_{b}=2 (e.g., two beam blocks per elevation direction), N=4 (e.g., four SSB beams per azimuth direction in a beam block), and M=3 (e.g., three SSB beams per elevation direction in a beam block). As described on FIG. 12, a two level SSB beams to SSB ID mapping may be based on an azimuth direction first for inter block and intra block mapping as described in connection with FIG. 10.

As described in connection with FIGS. 7 and 10, if the azimuth first sweep direction is applied, then the block indexing (k_{b}) for the sweep may be based on: k_{b}=iₐ+(iₑ−1)N_{b}, for iₐ=1, . . . , N_{b}, iₑ=1, . . . , M_{b}. In addition, if the azimuth first sweep direction intra block is applied, then beams indexing for intra block sweep (k) may be based on: k=jₐ+(jₑ−1)N, for jₐ=1, . . . , N, jₑ=1, . . . , M.

Then, based at least in part on the known SSB ID to SSB physical beam mapping pattern/sweeping, a UE may be able to prioritize and/or down select more relevant SSB IDs to be evaluated for a serving SSB beam and alternative SSB beams list tracking and P1 BM report evaluation. Based on the prioritization, different rate of evaluations may also be used on the UE side for SSB beams/IDs lists having a different priority based on SSB IDs classification into different categories (neighboring or spatially close or spatially distant SSB beams with respect to the current serving and the candidate SSB IDs list). Thus a more efficient SSB beams/IDs prioritization may provide UE power reduction for processing related to BM procedures and an improved tracking of the best beams list at the same time on the UE side.

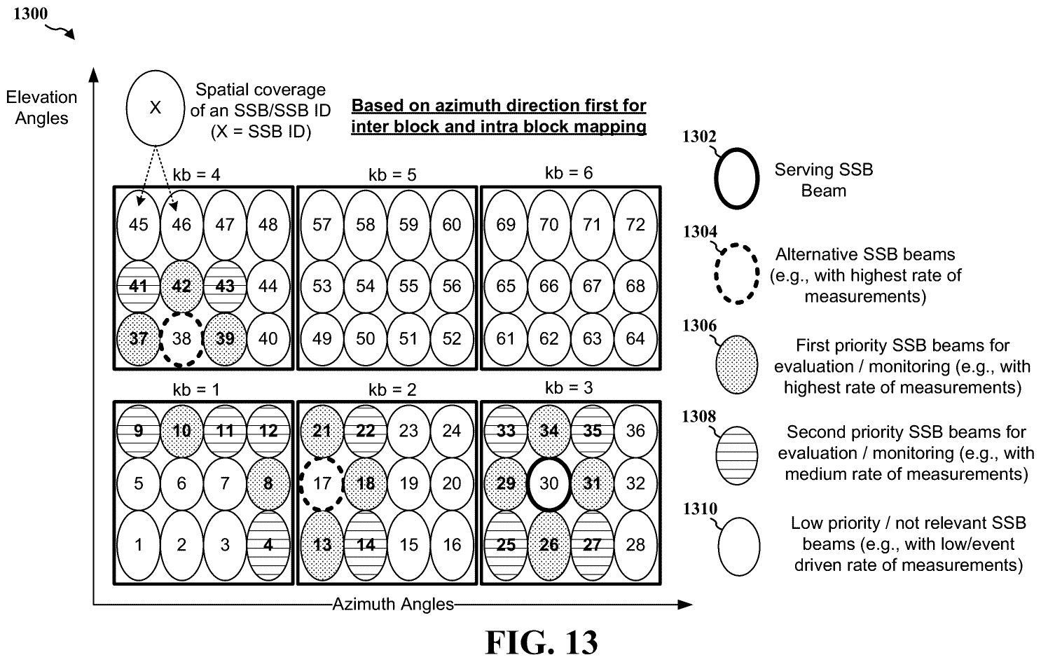

FIG. 13 is a diagram 1300 illustrating an example of prioritizing and/or down selecting SSB ID in accordance with various aspects of the present disclosure. Similar to the example shown in FIGS. 10 and 12, a base station may be configured to transmit 12 SSB beams over the azimuth dimension (or direction) and 6 SSB beams over the elevation dimension (e.g., resulting in a total of 72 SSB beams) that cover a spatial dimension for transmitting SSB. The SSB beams may further be subdivided into six beam blocks, such that N_{b}=3 (e.g., three beam blocks per azimuth direction), M_{b}=2 (e.g., two beam blocks per elevation direction), N=4 (e.g., four SSB beams per azimuth direction in a beam block), and M=3 (e.g., three SSB beams per elevation direction in a beam block), which may correspond to an azimuth direction first for inter block and intra block mapping as described in connection with FIGS. 10 and 12.

In one example, if a UE is communicating with the base station based on a serving SSB beam 1302 (e.g., SSB ID=30), the UE may be configured to prioritize measuring SSB beams that are more relevant to the serving SSB beam 1302, such as beams that are in proximity to the serving SSB beam 1302 in terms of their spatial coverage (e.g., over the azimuth direction, the elevation direction, or both). For example, SSB beams that are directly adjacent to the serving SSB beam 1302 may be classified by the UE as first priority SSB beams 1306 (e.g., SSB beams with highest rate of measurements), which may include SSB beams corresponding to SSB ID=26, 29, 31, and 34. SSB beams that are not directly adjacent to the serving SSB beam 1302 but are also in proximity to the serving SSB beam 1302 (e.g., SSB beams that are adjacent to at least two first priority SSB beams 1306, SSB beams with medium rate of measurements, etc.) may be classified by the UE as second priority SSB beams 1308, which may include SSB beams corresponding to SSB ID=25, 27, 33, and 35. Then, the rest of SSB beams that are further away from the serving SSB beam 1302 may be classified by the UE as low priority or not relevant SSB beams 1310 (e.g., SSB beams with low/event driven rate of measurements). As such, the UE may be configured to evaluate or monitor SSB beams based on their priority of classification. For example, the UE may be configured to measure or monitor the first priority SSB beams 1306 with a higher rate of measurements compared to the second priority SSB beams 1308, and/or measure the first priority SSB beams 1306 and the second priority SSB beams 1308 with a corresponding higher rate of measurements compared to low priority SSB beams 1310 that can be measured once over relatively long time duration or a measurements for low priority beams can be triggered by some list of events.

In another example, the UE may also prioritize measurements for SSB beams that are associated with an alternative or candidate SSB beams based on the same approach. For example, in addition to the serving SSB beam 1302, the UE may also maintain a list of alternative SSB beams 1304 that has measurements rate above a threshold (e.g., SSB beams with highest rate of measurements). Then, the UE may be configured to prioritize measuring SSB beams that are more relevant to alternative SSB beams 1304, such as beams that are in proximity to these alternative SSB beams 1304 in terms of their spatial coverage (e.g., over the azimuth direction, the elevation direction, or both). For example, if there are two alternative SSB beams 1304 that correspond to SSB ID=17 and 38, SSB beams that are directly adjacent to the two alternative SSB beams 1304 may be classified by the UE as first priority SSB beams 1306, which may include SSB beams corresponding to SSB ID=8, 10, 13, 18, 21, 37, 39, and 42. SSB beams that are not directly adjacent to the two alternative SSB beams 1304 but are also in proximity to the two alternative SSB beams 1304 (e.g., SSB beams that are adjacent to at least two first priority SSB beams 1306, SSB beams with medium rate of measurements, etc.) may be classified by the UE as second priority SSB beams 1308, which may include SSB beams corresponding to SSB ID=4, 9, 11, 12, 14, 22, 41, and 43. Then, the rest of SSB beams that are further away from the two alternative SSB beams 1304 may be classified by the UE as low priority or not relevant SSB beams 1310 (e.g., SSB beams with low/event driven rate of measurements). As such, the UE may be configured to evaluate or monitor SSB beams based on their priority of classification. For example, the UE may be configured to measure or monitor the first priority SSB beams 1306 with a higher rate of measurements compared to the second priority SSB beams 1308, and/or measure the first priority SSB beams 1306 and the second priority SSB beams 1308 with a corresponding higher rate of measurements compared to low priority SSB beams 1310 that can be measured once over relatively long time duration or a measurements for low priority beams can be triggered by some list of events (e.g. sudden beam quality deterioration over all the tracked by the UE serving and alternative beams list, significant UE movement speed increase, some NW reconfiguration related to BM procedures, etc.).

In one example, calculations that are to be done by the UE for determination of the neighboring beams (e.g., the first priority SSB beams 1306) for the serving SSB beam 1302 or for one or more alternative SSB beams 1304 may be based on the following. For example, the serving SSB beam 1302, or the base station beam (or a Tx side beam) may correspond/map to SSB ID=30 based on the mapping option addressed on FIG. 12 and based on the following SSB ID determination on the NW side correspondingly: k=6, k_{b}=3, K=4·3=12⇒SSS ID=6+2*12=30. Then, based on the SSB ID (and the known mapping pattern/parameters), the UE (or a Rx side) may calculate or determine at least one neighbor SSB beam for the serving SSB beam based on the following calculations: SSB ID=30, K=12⇒k_{b}=└30/12┘+1=3, k=mod(30,12)=6; and jₐ=mod(k, N)=mod(6,4)=2; jₑ=└k/N┘+1=└6/4┘+1=2. Then, location of neighboring beams in azimuth direction (on the UE side) may be calculated based on: jₐ+1=3; jₐ−1=1⇒kₙₑₓₜ_{_{azimuth}}=(jₐ+1)+(jₑ−1)N=3+4=7⇒SSB IDₙₑₓₜ_{_{azimuth}}=7+2*12=31, and kₚᵣₑᵥ_{_{azimuth}}=(jₐ−1)+(jₑ−1)N=1+4=5⇒SSB IDₚᵣₑᵥ_{_{azimuth}}=5+2*12=29.

In some examples, in case that jₐ+1>N, the next block (k_{b}+1) may be addressed with jₐ=1 for evaluation of SSB IDₙₑₓₜ_{_{azimuth}}; and in case that jₐ−1<1, the previous block (k_{b}−1) may be addressed with jₐ=N for evaluation of SSB IDₚᵣₑᵥ_{_{azimuth}} Neighboring beams in elevation direction may also be evaluated in a similar way (jₑ+1, jₑ−1 determination and then the corresponding to the SSB IDₙₑₓₜ_{ₑₗₑᵥₐₜᵢₒₙ}, SSB IDₚᵣₑᵥ_{ₑₗₑᵥₐₜᵢₒₙ}).

As aspects presented herein may provide a more efficient implementation of BM procedures on the UE side, such as the P1 BM reporting, there is likely less constraints and/or sensitivity on the UE side to support a high number of SSB resources to be considered or configured for SSB-based BM reporting. In a view of this consideration the following may further be implemented as a further or additional enhancement.

In one aspect, at least a portion or all existing SSB IDs/resources may be addressed or configured on the UE side for P1 BM reporting (by default implementation or definition). In other words, the UE may be configured to perform P1 BM reporting with less configurations from the network or without any configurations from the network. This may reduce the RRC configuration volume and may also eliminate any specification for RRC reconfiguration of SSB resources for P1 BM reporting (e.g., CSI report with reportQuantity=ssb-Index-RSRP/ssb-Index-SINR).

In some examples, as SSB based P1 BM report may include SS/PBCH resource block indicator (SSBRI) (e.g., SSBRI indicates index of a selected SSB resource from a list of the configured for measurement/monitoring SSB resources/IDs) and the corresponding reference symbol received power (RSRP) and/or signal to interference plus noise ratio (SINR) for the selected list of the best SSB beams, the report volume may depend on the SSBRI field size (e.g., depends on the number of the addressed SSB resources/IDs). In case that all SSB IDs are configured for reporting, SSBRI may equivalently be replaced by SSB ID. In one example, an SSB ID reporting may be done by means of a combination of the corresponding SSB block index (k_{b}) and SSB beam index within the block (k). SSB block index may be omitted for some of the beams/reports to reduce the report volume when reporting a list of the best SSB beams. For example, SSB block index (k_{b}) may be omitted for some of the reported beams (SSB IDs) if the same beam block is shared by several reported beams or in case that there is no change in the block index for the corresponding reported SSB beam compared to the previous report.

In another aspect of the present disclosure, as aspects of the present disclosure may enable a UE to track and categorize SSB beams more efficiently, BFD, RLM, and/or BFR beams/resources selection/tracking may be configured to be done autonomously on the UE side without network assistance, configuration, and/or reconfiguration (e.g., autonomous maintenance of BFD/BFR resources list). This may reduce RRC configuration volume and may also eliminate any specification for RRC reconfigurations associated with BFD, RLM, RLF, and/or BFR procedures. In some examples, lack of configuration for BFR resources/beams as suggested above may assume that BFR procedures are relying on CBRA (e.g., configured for all SSB beams) and may not be based on CFRA which may specify dedicated configurations per BFR candidate beam. In other examples, an intermediate approach may be applied where BFD, RLM, and/or BFR resources are indicated to or configured for a UE by means of anchor SSB block indexes instead of a specific list of SSB IDs/beam indexes with an assumption or a default configuration that the UE will search locally within the indicated beam block(s) for alternative and serving SSB beams tracking. Indicating SSB beams block index (k_{b}) instead of a specific SSB beam/ID may specify less updating/reconfigurations in case of some mobility and may also specify less configuration data in general (e.g., the number of SSB blocks may be lower than overall number of SSB beams/IDs).

In another aspect of the present disclosure, aspects of the present disclosure may enable a UE to track a longer list of alternative SSB beams, which in turn may improve maximum permissible exposure (MPE) related algorithms/flexibility and may also contribute to a more robust BFR procedures.

In another aspect of the present disclosure, aspects of the present disclosure may be applicable also in the context of neighboring cells measurements (e.g., radio resource management (RRM) procedures). Similar or same configurations and/or parametrization related to SSB beams sweeping/mapping of SSB IDs may be configured to a UE under MeasObjectNR information element (IE). SSB beams of one or more neighboring cells may be categorized on the UE side and a list of the most relevant beams may be tracked, monitored, and/or measured in a more efficient manner with a known SSB IDs to physical SSB beams mapping (e.g., similar to what was described in relation to P1 BM procedures for the serving cell). As such, a more “focused” measurements may be employed by the UE to reduce the UE power consumption and to improve neighboring cell beams tracking ability for a more robust handover (HO) procedure or process.

In another aspect of the present disclosure, for a UE to take advantage from/support the systematic and semi-deterministic SSB ID to physical SSB beams mapping/sweeping pattern from UE perspective discussed in connection between FIGS. 7 to 13, one or more parameters may be configured for the UE.

In one example, the dimensions of the 2D SSB beam block(s) (e.g., N, M) may be configured for a UE or known by the UE. For example, these parameters may be configured/indicated to the UE by a network (e.g., not predefined by the specification) to provide flexibility for the network side and also to allow customization per deployment and different beam sweeping implementation aspects related to the network side. In addition, single block of SSB beams covering all the SSB beams/IDs (e.g., described in connection with FIGS. 7 to 9) may be configured as a special case of the beam blocking, as described in relation to the two levels SSB beams mapping hierarchy, and/or the sweeping approach.

In another example, whether to apply azimuth direction first or elevation direction first SSB beam sweep for inter block and/or intra block mapping/sweeping may also be configured for a UE or predefined by the specification/known by the UE. For example, different combinations of azimuth direction first and elevation direction first may be configured for inter block mapping and intra block mapping. In addition, these two parameters or at least one of these two parameters may be predefined by a rule or a standard/specification, but for an improved flexibility they may also be configurable by the NW.

In another example, the number of blocks in the primary sweep dimension (e.g., N_{b} or M_{b}) may also be configured for a UE or predefined by the specification/known by the UE. For example providing an indication of just one of the two parameters (N_{b} or M_{b}) to the UE may be sufficient since the another one of the two parameters (e.g., the one no being indicated) may be determined on the UE side given the known total number of SSB beams configuration (e.g., RRC configuration) and the block size that can be determined based on N,M parameters configuration (e.g., K=N·M).

In some examples, the parameters discussed above may be configured or indicated to a UE via MIB or SIB. For example, in the scenario that the communication is based on sub-THz (or any other new band or new specification scenario where there is no backward compatibility specification), both MIB or SIB may be used. On the other hand, in the scenario that aspects of the present disclosure are applied as an enhancement for FR2/FR2x or 5G NR in general, backward compatibility specification may be provided as follows.

In one aspect, SSB ID/SSB slot index signaling (e.g., via PBCH) may be done in a way that does not depend on the mapping described herein. For example, the semi-deterministic SSB IDs mapping to physical SSB beams as suggested by the present disclosure may not change anything in relation with SSB ID signaling.

In another aspect, one or more of the parameters discussed above may be signaled via a new other SIB (e.g., SIB10), which may be transmitted on system information (SI) request basis. For example, SI request may be initiated by a capable or “new” UEs, or configured/indicated to the UE via RRC or other messaging.

With the above configuration and/or indication, employment of the aspects described herein may become transparent to UEs that are not capable of taking advantage from applying the systematic and semi-deterministic 2D mapping side information/configuration for SSB IDs classification and further prioritization for more efficient BM as described herein (UEs that are unable to take advantage of the extra information regarding SSB IDs to physical SSB beams mapping), e.g., these UEs (legacy UEs) may continue to operate any BM related procedures in a default or original way.

In another aspect of the present disclosure, one or more parameters discussed above, such as parameters associated with the semi-deterministic SSB ID to physical SSB beams mapping/sweeping pattern described above, may also be configured for a UE for neighboring cells measurements. For example, this configuration/information may be added under MeasObjectNR information element (e.g., to enable backward compatibility). In case that backward compatibility is not specified, this configuration/information may be also indicated via one of the existing SIBs (e.g., SIB4).

Aspects presented herein may improve UE power consumption associated with BM procedures and related processing, and also with neighboring cells measurements procedures. Also, aspects presented herein may enable a UE to take a more active role in overall beam management process for the communication link between the UE and a base station/network, such as enable the UE to configure autonomous dynamic SSB resources selection and tracking for BM reporting, BFD, RLM, and/or BFR procedures, etc. Thus, the overall RRC configuration volume may be reduced and RRC reconfigurations may be eliminated or at least a required RRC reconfiguration rate may be reduced. Aspects presented herein may further enhance beam management procedures on the UE side. For example, a better tracking ability of the candidate/alternative SSB beams (e.g., for P1 BM, BFD, RLM, BFR, and/or MPE procedures) may be achieved on the UE side. The UE may have the ability to track a more extended list of candidate beams with a reduced processing/power consumption characteristics on UE side. The UE may also apply more robust BFR and MPE related procedures. The mobility of the UE (e.g., higher UE movement speeds) may be improved with a more robust BM procedures in relation to the described herein semi-deterministic SSB beams sweeping pattern. More robust BM and neighboring cell measurement procedures as described above may also provide for a more robust HO procedures.

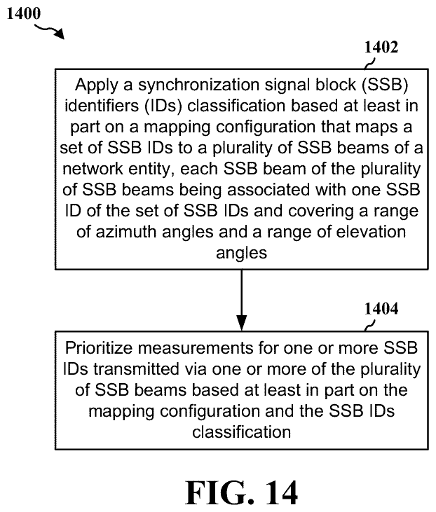

FIG. 14 is a flowchart 1400 of a method of wireless communication. The method may be performed by a UE (e.g., the UE 104; the apparatus 1504). The method may enable the UE to measure SSB beams of a base station in a more efficient manner.

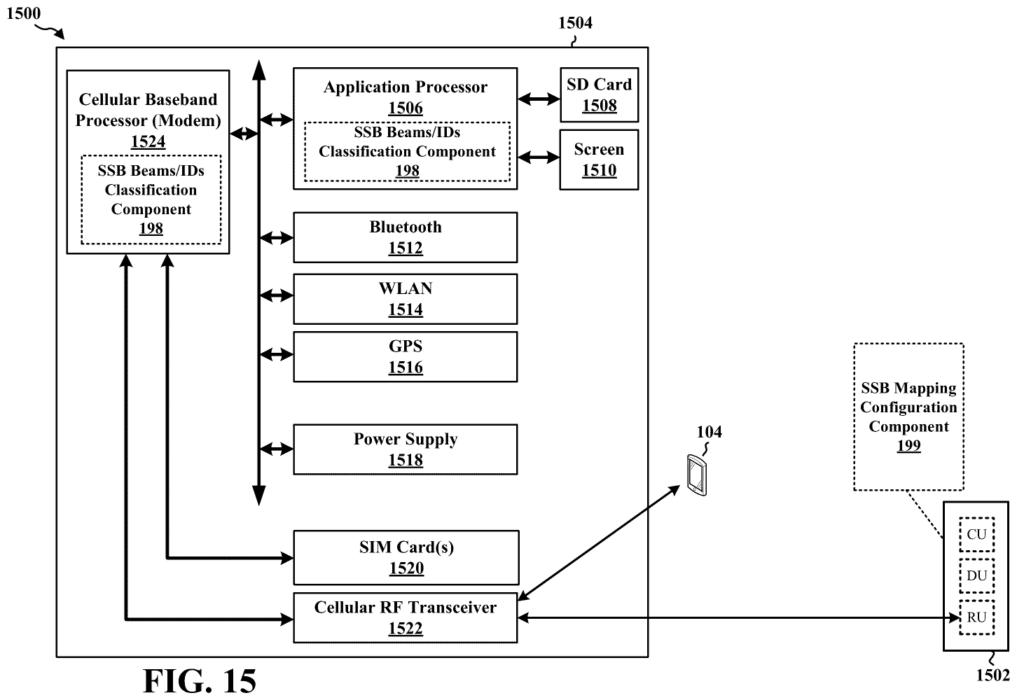

At 1402, the UE may apply an SSB IDs classification based at least in part on a mapping configuration that maps a set of SSB IDs to a plurality of SSB beams of a network entity, where each SSB beam of the plurality of SSB beams may be associated with one SSB ID of the set of SSB IDs and covering a range of azimuth angles and a range of elevation angles, such as described in connection with FIGS. 7 to 13. For example, as shown by FIG. 7, a UE may apply an SSB IDs classification based at least in part on a mapping configuration that maps a set of SSB IDs to a plurality of SSB beams, where each SSB beam may cover a range of azimuth angles and a range of elevation angles. The application of the mapping may be performed by, e.g., the SSB mapping process component 198 of the apparatus 1504 in FIG. 15.

In one example, the network entity may include a base station or a component of the base station.

In another example, the mapping configuration may be a 2D mapping that includes an azimuth dimension and an elevation dimension, such that the each SSB beam in the plurality of SSB beams may cover the range of azimuth angles in the azimuth dimension and the range of elevation angles in the elevation dimension.

In another example, different SSB beams may cover different ranges of azimuth angles or different ranges of elevation angles.

In another example, the plurality of SSB beams may correspond to K SSB beams that cover N ranges of azimuth angles and M ranges of elevation angles. In such an example, the mapping configuration may map K SSB IDs to the K SSB beams initially based on an azimuthal direction and subsequently based on an elevation direction, or the mapping configuration may map K SSB IDs to the K SSB beams initially based on an elevation direction and subsequently based on an azimuthal direction.

In another example, the plurality of SSB beams may be grouped into multiple beam blocks, where each of the multiple beam blocks may include k SSB beams that cover n ranges of azimuth angles and m ranges of elevation angles. In such an example, the mapping configuration may map k SSB IDs to the k SSB beams in the each of the multiple beam blocks initially based on an azimuthal direction and subsequently based on an elevation direction, or the mapping configuration may map k SSB IDs to the k SSB beams in the each of the multiple beam blocks initially based on an elevation direction and subsequently based on an azimuthal direction. In such an example, the mapping configuration may map k SSB IDs to the k SSB beams in a first beam block of the multiple beam blocks before mapping next k SSB IDs to the k SSB beams in a second beam block of the multiple beam blocks, the second beam block being adjacent to the first beam block in an elevation direction or azimuth direction.

In another example, the UE may receive, from the network entity, one or more parameters associated with the mapping configuration via a MIB or an SIB.

In another example, the plurality of SSB beams may include a serving SSB beam and one or more candidate SSB beams and at least one neighbor SSB beam that is adjacent to the serving SSB beam or the one or more candidate SSB beams. In such an example, the UE may determine a first SSB ID that corresponds to the serving SSB beam or one of the one or more candidate SSB beams based on the mapping configuration, and the UE may calculate at least one second SSB ID for the at least one neighbor SSB beam based on the first SSB ID and the mapping configuration, and the UE may measure the at least one second SSB ID.

At 1404, the UE may prioritize measurements for one or more SSB IDs transmitted via one or more of the plurality of SSB beams based at least in part on the mapping configuration and the SSB IDs classification, such as described in connection with FIGS. 7 to 13. For example, as shown by FIG. 13, a UE may measure beams that are more relevant (e.g., closer in spatial dimension) to the serving SSB beam 1302, such as the first priority SSB beams 1306 and/or the second priority SSB beams 1308. The prioritization of the measurements may be performed by, e.g., the SSB mapping process component 198 of the apparatus 1504 in FIG. 15.

In one example, to prioritize the measurements for the one or more SSB IDs transmitted via the one or more of the plurality of SSB beams based at least in part on the mapping configuration and the SSB IDs classification, the UE may classify the plurality of SSB IDs into multiple priority levels or measurement rates based on the SSB IDs classification, wherein a first set of SSB IDs corresponding to a first set of SSBs that are spatially closer to a serving beam or a candidate beam is classified with a higher priority level or measurement rate, and a second set of the SSB IDs corresponding to a second set of SSBs that are spatially further away from the serving beam or the candidate beam compared to the first set of SSBs is classified with a lower priority level or measurement rate, and then the UE may measure the first set of SSB IDs and the second set of SSBs based on their corresponding priority levels or measurement rates.

In another example, a second mapping configuration may map a second set of SSB IDs to a second set of SSB beams of a second network entity, the second network entity being a neighboring cell of the network entity. In such an example, the UE may prioritize measurements for at least one SSB ID transmitted via at least one SSB beam of the second network entity based at least in part on the mapping configuration and the SSB IDs classification.

FIG. 15 is a diagram 1500 illustrating an example of a hardware implementation for an apparatus 1504 and a network entity 1502. The apparatus 1504 may be a UE, a component of a UE, or may implement UE functionality. The network entity 1502 may be a BS, a component of a BS, or may implement BS functionality. In some aspects, the apparatus 1504 may include a cellular baseband processor 1524 (also referred to as a modem) coupled to a cellular RF transceiver 1522. In some aspects, the apparatus 1504 may further include one or more subscriber identity modules (SIM) cards 1520, an application processor 1506 coupled to a secure digital (SD) card 1508 and a screen 1510, a Bluetooth module 1512, a wireless local area network (WLAN) module 1514, a Global Positioning System (GPS) module 1516, or a power supply 1518. The cellular baseband processor 1524 communicates through the cellular RF transceiver 1522 with the UE 104 and/or with an RU associated with the network entity 1502. The RU is either part of the network entity 1502 or is in communication with the network entity 1502. The network entity 1502 may include one or more of the CU, DU, and the RU. The cellular baseband processor 1524 and the application processor 1506 may each include a computer-readable medium/memory. Each computer-readable medium/memory may be non-transitory. The cellular baseband processor 1524 and the application processor 1506 are each responsible for general processing, including the execution of software stored on the computer-readable medium/memory. The software, when executed by the cellular baseband processor 1524/application processor 1506, causes the cellular baseband processor 1524/application processor 1506 to perform the various functions described supra. The computer-readable medium/memory may also be used for storing data that is manipulated by the cellular baseband processor 1524/application processor 1506 when executing software. The cellular baseband processor 1524/application processor 1506 may be a component of the UE 350 and may include the memory 360 and/or at least one of the TX processor 368, the RX processor 356, and the controller/processor 359. In one configuration, the apparatus 1504 may be a processor chip (modem and/or application) and include just the cellular baseband processor 1524 and/or the application processor 1506, and in another configuration, the apparatus 1504 may be the entire UE (e.g., see 350 of FIG. 3) and include the additional modules of the apparatus 1504.

As discussed supra, the SSB mapping process component 198 is configured to apply an SSB IDs classification based at least in part on a mapping configuration that maps a set of SSB IDs to a plurality of SSB beams of a network entity, each SSB beam of the plurality of SSB beams being associated with one SSB ID of the set of SSB IDs and covering a range of azimuth angles and a range of elevation angles, and prioritize measurements for one or more SSB IDs transmitted via one or more of the plurality of SSB beams based at least in part on the mapping configuration and the SSB IDs classification. The SSB mapping process component 198 may be within the cellular baseband processor 1524, the application processor 1506, or both the cellular baseband processor 1524 and the application processor 1506. The SSB mapping process component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1504 may include a variety of components configured for various functions. In one configuration, the apparatus 1504, and in particular the cellular baseband processor 1524 and/or the application processor 1506, includes means for applying an SSB IDs classification based at least in part on a mapping configuration that maps a set of SSB IDs to a plurality of SSB beams of a network entity, each SSB beam of the plurality of SSB beams being associated with one SSB ID of the set of SSB IDs and covering a range of azimuth angles and a range of elevation angles; means for prioritizing measurements for one or more SSB IDs transmitted via one or more of the plurality of SSB beams based at least in part on the mapping configuration and the SSB IDs classification; means for receiving, from the network entity, one or more parameters associated with the mapping configuration via a MIB or an SIB; means for measuring the at least one neighbor SSB beam based on at least one SSB ID of the set of SSB IDs associated with the serving SSB beam and the at least one neighbor SSB beam; and means for measuring a first subset of the plurality of SSB beams prior to measuring a second subset of the plurality of SSB beams, where the first subset of the plurality of SSB beams is closer to a serving beam compared to the second subset of the plurality of SSB beams.

The means may be the SSB mapping process component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

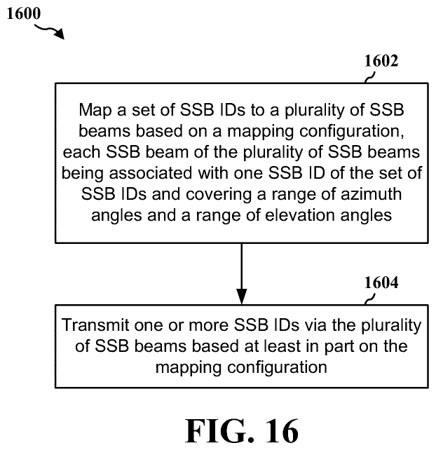

FIG. 16 is a flowchart 1600 of a method of wireless communication. The method may be performed by a base station (e.g., the base station 102; the network entity 1702). The method map may enable the base station to map SSB IDs to SSB beams based on a two dimensional mapping.

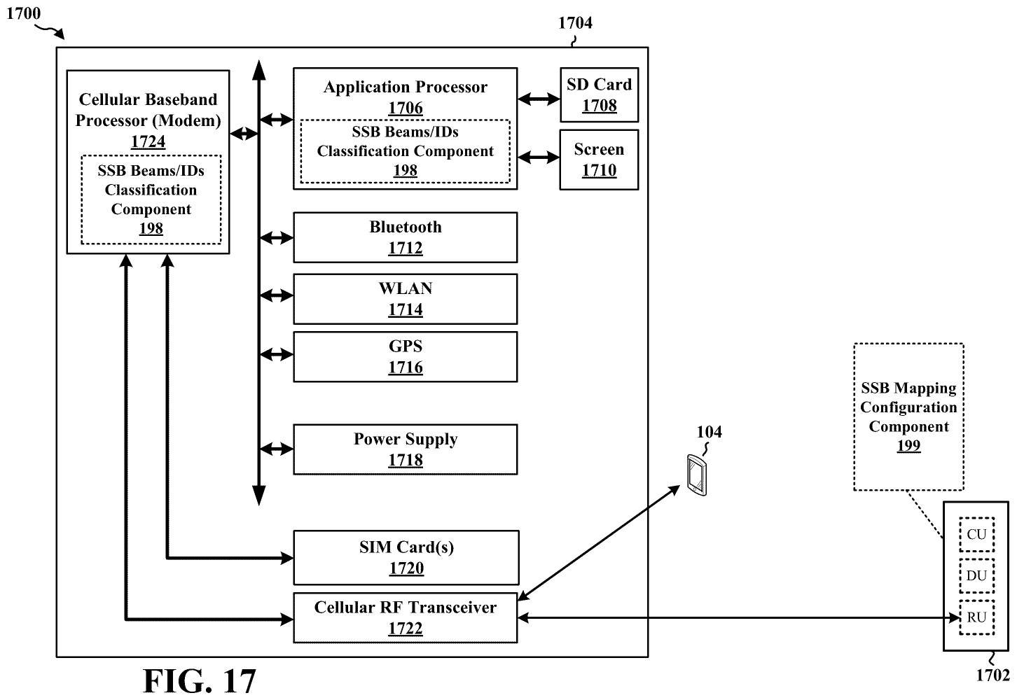

At 1602, the base station may map a set of SSB IDs to a plurality of SSB beams based on a mapping configuration, each SSB beam of the plurality of SSB beams being associated with one SSB ID of the set of SSB IDs and covering a range of azimuth angles and a range of elevation angles, such as described in connection with FIGS. 7 to 13. For example, as shown by FIG. 7, a base station may map a set of SSB IDs to a plurality of SSB beams, where each SSB beam may cover a range of azimuth angles and a range of elevation angles. The mapping of the set of SSB IDs to a plurality of SSB beams may be performed by, e.g., the SSB mapping configuration component 199 of the network entity 1702 in FIG. 17.

In one example, the network entity may include a base station or a component of the base station.

In another example, the mapping configuration may be a two-dimensional mapping that includes an azimuth dimension and an elevation dimension, such that the each SSB beam in the plurality of SSB beams may cover the range of azimuth angles in the azimuth dimension and the range of elevation angles in the elevation dimension.

In another example, different SSB beams may cover different ranges of azimuth angles or different ranges of elevation angles.

In another example, the plurality of SSB beams corresponds to K SSB beams that cover N ranges of azimuth angles and M ranges of elevation angles. In such an example, the mapping configuration may map K SSB IDs to the K SSB beams initially based on an azimuthal direction and subsequently based on an elevation direction, or the mapping configuration may map K SSB IDs to the K SSB beams initially based on an elevation direction and subsequently based on an azimuthal direction.

In another example, the plurality of SSB beams may be grouped into multiple beam blocks, where each of the multiple beam blocks may include k SSB beams that cover n ranges of azimuth angles and m ranges of elevation angles. In such an example, the mapping configuration may map k SSB IDs to the k SSB beams in the each of the multiple beam blocks initially based on an azimuthal direction and subsequently based on an elevation direction, or the mapping configuration may map k SSB IDs to the k SSB beams in the each of the multiple beam blocks initially based on an elevation direction first and subsequently based on an azimuthal direction. In such an example, the mapping configuration may map k SSB IDs to the k SSB beams in a first beam block of the multiple beam blocks before mapping next k SSB IDs to the k SSB beams in a second beam block of the multiple beam blocks, the second beam block being adjacent to the first beam block in an elevation direction or azimuth direction.

In another example, the base station may transmit one or more parameters associated with the mapping configuration via a MIB or an SIB.

At 1604, the base station may transmit one or more SSB IDs via the plurality of SSB beams based at least in part on the mapping configuration, such as described in connection with FIGS. 7 to 13. For example, as shown by FIGS. 8 and 9, a base station may transmit one or more SSBs via the plurality of SSB beams based at least in part on the mapping configuration. The transmission of the one or more SSBs may be performed by, e.g., the SSB mapping configuration component 199 of the network entity 1702 in FIG. 17.

FIG. 17 is a diagram 1700 illustrating an example of a hardware implementation for an apparatus 1704 and a network entity 1702. The apparatus 1704 may be a UE, a component of a UE, or may implement UE functionality. The network entity 1702 may be a BS, a component of a BS, or may implement BS functionality. In some aspects, the apparatus 1704 may include a cellular baseband processor 1724 (also referred to as a modem) coupled to a cellular RF transceiver 1722. In some aspects, the apparatus 1704 may further include one or more subscriber identity modules (SIM) cards 1720, an application processor 1706 coupled to a secure digital (SD) card 1708 and a screen 1710, a Bluetooth module 1712, a wireless local area network (WLAN) module 1714, a Global Positioning System (GPS) module 1716, or a power supply 1718. The cellular baseband processor 1724 communicates through the cellular RF transceiver 1722 with the UE 104 and/or with an RU associated with the network entity 1702. The RU is either part of the network entity 1702 or is in communication with the network entity 1702. The network entity 1702 may include one or more of the CU, DU, and the RU. The cellular baseband processor 1724 and the application processor 1706 may each include a computer-readable medium/memory. Each computer-readable medium/memory may be non-transitory. The cellular baseband processor 1724 and the application processor 1706 are each responsible for general processing, including the execution of software stored on the computer-readable medium/memory. The software, when executed by the cellular baseband processor 1724/application processor 1706, causes the cellular baseband processor 1724/application processor 1706 to perform the various functions described supra. The computer-readable medium/memory may also be used for storing data that is manipulated by the cellular baseband processor 1724/application processor 1706 when executing software. The cellular baseband processor 1724/application processor 1706 may be a component of the UE 350 and may include the memory 360 and/or at least one of the TX processor 368, the RX processor 356, and the controller/processor 359. In one configuration, the apparatus 1704 may be a processor chip (modem and/or application) and include just the cellular baseband processor 1724 and/or the application processor 1706, and in another configuration, the apparatus 1704 may be the entire UE (e.g., see 350 of FIG. 3) and include the additional modules of the apparatus 1704.

As discussed supra, the SSB mapping configuration component 199 is configured to map a set of SSB IDs to a plurality of SSB beams based on a mapping configuration, each SSB beam of the plurality of SSB beams being associated with one SSB ID of the set of SSB IDs and covering a range of azimuth angles and a range of elevation angles; and transmit one or more SSB IDs via the plurality of SSB beams based at least in part on the mapping configuration. The SSB mapping configuration component 199 may be within one or more processors (e.g., BBU(s)) of one or more of the CU, DU, and the RU. The SSB mapping configuration component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1702 may include a variety of components configured for various functions. In one configuration, the network entity 1702 includes means for mapping a set of SSB IDs to a plurality of SSB beams based on a mapping configuration, each SSB beam of the plurality of SSB beams being associated with one SSB ID of the set of SSB IDs and covering a range of azimuth angles and a range of elevation angles; means for transmitting one or more SSB IDs via the plurality of SSB beams based at least in part on the mapping configuration; and means for transmitting one or more parameters associated with the mapping configuration via a MIB or an SIB.

The means may be the SSB mapping configuration component 199 of the network entity 1702 configured to perform the functions recited by the means. As described supra, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used in this disclosure outside of the claims, the phrase “based on” is inclusive of all interpretations and shall not be limited to any single interpretation unless specifically recited or indicated as such. For example, the phrase “based on A” (where “A” may be information, a condition, a factor, or the like) may be interpreted as: “based at least on A,” “based in part on A,” “based at least in part on A,” “based only on A,” or “based solely on A.” Accordingly, as disclosed herein, “based on A” may, in one aspect, refer to “based at least on A.” In another aspect, “based on A” may refer to “based in part on A.” In another aspect, “based on A” may refer to “based at least in part on A.” In another aspect, “based on A” may refer to “based only on A.” In another aspect, “based on A” may refer to “based solely on A.” In another aspect, “based on A” may refer to any combination of interpretations in the alternative. As used in the claims, the phrase “based on A” shall be interpreted as “based at least on A” unless specifically recited differently.

The following aspects are illustrative only and may be combined with other aspects or teachings described herein, without limitation.

Aspect 1 is an apparatus for wireless communication including at least one sensor, and at least one processor coupled to a memory and configured to: apply an SSB IDs classification based at least in part on a mapping configuration that maps a set of SSB IDs to a plurality of SSB beams of a network entity, each SSB beam of the plurality of SSB beams being associated with one SSB ID of the set of SSB IDs and covering a range of azimuth angles and a range of elevation angles; and prioritize measurements for one or more SSB IDs transmitted via one or more of the plurality of SSB beams based at least in part on the mapping configuration and the SSB IDs classification.

Aspect 2 is the apparatus of aspect 1, where the network entity includes a base station or a component of the base station.

Aspect 3 is the apparatus of any of aspects 1 and 2, where the mapping configuration is a 2D mapping that includes an azimuth dimension and an elevation dimension, such that the each SSB beam in the plurality of SSB beams covers the range of azimuth angles in the azimuth dimension and the range of elevation angles in the elevation dimension.

Aspect 4 is the apparatus of any of aspects 1 to 3, where different SSB beams cover different ranges of azimuth angles or different ranges of elevation angles.

Aspect 5 is the apparatus of any of aspects 1 to 4, where the plurality of SSB beams corresponds to K SSB beams that cover N ranges of azimuth angles and M ranges of elevation angles.

Aspect 6 is the apparatus of any of aspects 1 to 5, where the mapping configuration maps K SSB IDs to the K SSB beams initially based on an azimuthal direction and subsequently based on an elevation direction.

Aspect 7 is the apparatus of any of aspects 1 to 6, where the mapping configuration maps K SSB IDs to the K SSB beams initially based on an elevation direction and subsequently based on an azimuthal direction.

Aspect 8 is the apparatus of any of aspects 1 to 7, where the plurality of SSB beams are grouped into multiple beam blocks, each of the multiple beam blocks including k SSB beams that cover n ranges of azimuth angles and m ranges of elevation angles.

Aspect 9 is the apparatus of any of aspects 1 to 8, where the mapping configuration maps k SSB IDs to the k SSB beams in the each of the multiple beam blocks initially based on an azimuthal direction and subsequently based on an elevation direction.

Aspect 10 is the apparatus of any of aspects 1 to 9, where the mapping configuration maps k SSB IDs to the k SSB beams in the each of the multiple beam blocks initially based on an elevation direction and subsequently based on an azimuthal direction.

Aspect 11 is the apparatus of any of aspects 1 to 10, where the mapping configuration maps k SSB IDs to the k SSB beams in a first beam block of the multiple beam blocks before mapping next k SSB IDs to the k SSB beams in a second beam block of the multiple beam blocks, the second beam block being adjacent to the first beam block in an elevation direction or azimuth direction.

Aspect 12 is the apparatus of any of aspects 1 to 11, where the at least one processor is configured to: receive, from the network entity, one or more parameters associated with the mapping configuration via a master information block or a system information block.

Aspect 13 is the apparatus of any of aspects 1 to 12, where the plurality of SSB beams include a serving SSB beam and one or more candidate SSB beams and at least one neighbor SSB beam that is adjacent to the serving SSB beam or the one or more candidate SSB beams, the at least one processor being further configured to: determine a first SSB ID that corresponds to the serving SSB beam or to one of the one or more candidate SSB beams based on the mapping configuration; calculate at least one second SSB ID for the at least one neighbor SSB beam based on the first SSB ID and the mapping configuration; and measure the at least one second SSB ID.

Aspect 14 is the apparatus of any of aspects 1 to 13, where to prioritize the measurements for the one or more SSB IDs transmitted via the one or more of the plurality of SSB beams based at least in part on the mapping configuration and the SSB IDs classification, the at least one processor being further configured to: classify the plurality of SSB IDs into multiple priority levels or measurement rates based on the SSB IDs classification, wherein a first set of SSB IDs corresponding to a first set of SSBs that are spatially closer to a serving beam or a candidate beam is classified with a higher priority level or measurement rate, and a second set of the SSB IDs corresponding to a second set of SSBs that are spatially further away from the serving beam or the candidate beam compared to the first set of SSBs is classified with a lower priority level or measurement rate; and measure the first set of SSB IDs and the second set of SSBs based on their corresponding priority levels or measurement rates.

Aspect 15 is the apparatus of any of aspects 1 to 14, where a second mapping configuration maps a second set of SSB IDs to a second set of SSB beams of a second network entity, the second network entity being a neighboring cell of the network entity, the at least one processor is further configured to: prioritize measurements for at least one SSB ID transmitted via at least one SSB beam of the second network entity based at least in part on the mapping configuration and the SSB IDs classification.

Aspect 16 is the apparatus of any of aspects 1 to 15 further including at least one of a transceiver or an antenna coupled to the at least one processor.

Aspect 17 is a method of wireless communication for implementing any of aspects 1 to 16.

Aspect 18 is an apparatus for wireless communication including means for implementing any of aspects 1 to 16.

Aspect 19 is a non-transitory computer-readable medium storing computer executable code, where the code when executed by a processor causes the processor to implement any of aspects 1 to 16.

Aspect 20 is an apparatus for wireless communication including at least one sensor, and at least one processor coupled to a memory and configured to: map a set of SSB IDs to a plurality of SSB beams based on a mapping configuration, each SSB beam of the plurality of SSB beams being associated with one SSB ID of the set of SSB IDs and covering a range of azimuth angles and a range of elevation angles; and transmit one or more SSB IDs via the plurality of SSB beams based at least in part on the mapping configuration.

Aspect 21 is the apparatus of aspect 20, where the network entity includes a base station or a component of the base station.

Aspect 22 is the apparatus of any of aspects 20 and 21, where the mapping configuration is a 2D mapping that includes an azimuth dimension and an elevation dimension, such that the each SSB beam in the plurality of SSB beams covers the range of azimuth angles in the azimuth dimension and the range of elevation angles in the elevation dimension.

Aspect 23 is the apparatus of any of aspects 20 to 22, where different SSB beams cover different ranges of azimuth angles or different ranges of elevation angles.

Aspect 24 is the apparatus of any of aspects 20 to 23, where the plurality of SSB beams corresponds to K SSB beams that cover N ranges of azimuth angles and M ranges of elevation angles.

Aspect 25 is the apparatus of any of aspects 20 to 24, where the mapping configuration maps K SSB IDs to the K SSB beams initially based on an azimuthal direction and subsequently based on an elevation direction.

Aspect 26 is the apparatus of any of aspects 20 to 25, where the mapping configuration maps K SSB IDs to the K SSB beams initially based on an elevation direction and subsequently based on an azimuthal direction.

Aspect 27 is the apparatus of any of aspects 20 to 26, where the plurality of SSB beams are grouped into multiple beam blocks, each of the multiple beam blocks including k SSB beams that cover n ranges of azimuth angles and m ranges of elevation angles.

Aspect 28 is the apparatus of any of aspects 20 to 27, where the mapping configuration maps k SSB IDs to the k SSB beams in the each of the multiple beam blocks initially based on an azimuthal direction and subsequently based on an elevation direction.

Aspect 29 is the apparatus of any of aspects 20 to 28, where the mapping configuration maps k SSB IDs to the k SSB beams in the each of the multiple beam blocks initially based on an elevation direction first and subsequently based on an azimuthal direction.

Aspect 30 is the apparatus of any of aspects 20 to 29, where the mapping configuration maps k SSB IDs to the k SSB beams in a first beam block of the multiple beam blocks before mapping next k SSB IDs to the k SSB beams in a second beam block of the multiple beam blocks, the second beam block being adjacent to the first beam block in an elevation direction or azimuth direction.

Aspect 31 is the apparatus of any of aspects 20 to 29 further including at least one of a transceiver or an antenna coupled to the at least one processor.

Aspect 32 is a method of wireless communication for implementing any of aspects 20 to 31.

Aspect 33 is an apparatus for wireless communication including means for implementing any of aspects 20 to 31.

Aspect 34 is a non-transitory computer-readable medium storing computer executable code, where the code when executed by a processor causes the processor to implement any of aspects 20 to 31.

What is claimed is:

1. An apparatus for wireless communication at a user equipment (UE), comprising:
a memory; and
at least one processor coupled to the memory and, based at least in part on information stored in the memory, the at least one processor is configured to:
apply a synchronization signal block (SSB) identifiers (IDs) classification based at least in part on a mapping configuration that maps a set of SSB IDs to a plurality of SSB beams of a network entity, each SSB beam of the plurality of SSB beams being associated with one SSB ID of the set of SSB IDs and covering a range of azimuth angles and a range of elevation angles; and
prioritize measurements for one or more SSB IDs transmitted via one or more of the plurality of SSB beams based at least in part on the mapping configuration and the SSB IDs classification.

2. The apparatus of claim 1, wherein the network entity includes a base station or a component of the base station.

3. The apparatus of claim 1, wherein the mapping configuration is a two-dimensional (2D) mapping that includes an azimuth dimension and an elevation dimension, such that the each SSB beam in the plurality of SSB beams covers the range of azimuth angles in the azimuth dimension and the range of elevation angles in the elevation dimension.

4. The apparatus of claim 1, wherein different SSB beams cover different ranges of azimuth angles or different ranges of elevation angles.

5. The apparatus of claim 1, wherein the plurality of SSB beams corresponds to K SSB beams that cover N ranges of azimuth angles and M ranges of elevation angles.

6. The apparatus of claim 5, wherein the mapping configuration maps K SSB IDs to the K SSB beams initially based on an azimuthal direction and subsequently based on an elevation direction.

7. The apparatus of claim 5, wherein the mapping configuration maps K SSB IDs to the K SSB beams initially based on an elevation direction and subsequently based on an azimuthal direction.

8. The apparatus of claim 1, wherein the plurality of SSB beams are grouped into multiple beam blocks, each of the multiple beam blocks including k SSB beams that cover n ranges of azimuth angles and m ranges of elevation angles.

9. The apparatus of claim 8, wherein the mapping configuration maps k SSB IDs to the k SSB beams in the each of the multiple beam blocks initially based on an azimuthal direction and subsequently based on an elevation direction.

10. The apparatus of claim 8, wherein the mapping configuration maps k SSB IDs to the k SSB beams in the each of the multiple beam blocks initially based on an elevation direction and subsequently based on an azimuthal direction.

11. The apparatus of claim 8, wherein the mapping configuration maps k SSB IDs to the k SSB beams in a first beam block of the multiple beam blocks before mapping next k SSB IDs to the k SSB beams in a second beam block of the multiple beam blocks, the second beam block being adjacent to the first beam block in an elevation direction or azimuth direction.

12. The apparatus of claim 1, wherein the at least one processor is configured to:
receive, from the network entity, one or more parameters associated with the mapping configuration via a master information block (MIB) or a system information block (SIB).

13. The apparatus of claim 1, wherein the plurality of SSB beams include a serving SSB beam and one or more candidate SSB beams and at least one neighbor SSB beam that is adjacent to the serving SSB beam or to the one or more candidate SSB beams, the at least one processor being further configured to:
determine a first SSB ID that corresponds to the serving SSB beam or to one of the one or more candidate SSB beams based on the mapping configuration; and
calculate at least one second SSB ID for the at least one neighbor SSB beam based on the first SSB ID and the mapping configuration; and prioritize measurement of the at least one second SSB ID.

14. The apparatus of claim 1, wherein to prioritize the measurements for the one or more SSB IDs transmitted via the one or more of the plurality of SSB beams based at least in part on the mapping configuration and the SSB IDs classification, the at least one processor being further configured to:
classify the plurality of SSB IDs into multiple priority levels based on the mapping and employ different measurement rates based on the SSB IDs classification, wherein a first set of SSB IDs corresponding to a first set of SSBs that are spatially closer to a serving beam or a candidate beam is classified with a higher priority level or measurement rate, and a second set of the SSB IDs corresponding to a second set of SSBs that are spatially further away from the serving beam or the candidate beam compared to the first set of SSBs is classified with a lower priority level or measurement rate; and
measure the first set of SSB IDs and the second set of SSBs based on their corresponding priority levels or measurement rates.

15. The apparatus of claim 1, wherein a second mapping configuration maps a second set of SSB IDs to a second set of SSB beams of a second network entity, the second network entity being a neighboring cell of the network entity, the at least one processor is further configured to:
prioritize measurements for at least one SSB ID transmitted via at least one SSB beam of the second network entity based at least in part on the second mapping configuration and the SSB IDs classification.

16. A method of wireless communication at a user equipment (UE), comprising:
applying a synchronization signal block (SSB) identifiers (IDs) classification based at least in part on a mapping configuration that maps a set of SSB IDs to a plurality of SSB beams of a network entity, each SSB beam of the plurality of SSB beams being associated with one SSB ID of the set of SSB IDs and covering a range of azimuth angles and a range of elevation angles; and
prioritizing measurements for one or more SSB IDs transmitted via one or more of the plurality of SSB beams based at least in part on the mapping configuration and the SSB IDs classification.

17. An apparatus for wireless communication at a network entity, comprising:
a memory; and
at least one processor coupled to the memory and, based at least in part on information stored in the memory, the at least one processor is configured to:
map a set of synchronization signal block (SSB) identifiers (IDs) to a plurality of SSB beams based on a mapping configuration, each SSB beam of the plurality of SSB beams being associated with one SSB ID of the set of SSB IDs and covering a range of azimuth angles and a range of elevation angles; and
transmit one or more SSB IDs via the plurality of SSB beams based at least in part on the mapping configuration.

18. The apparatus of claim 17, wherein the network entity includes a base station or a component of the base station.

19. The apparatus of claim 17, wherein the mapping configuration is a two-dimensional (2D) mapping that includes an azimuth dimension and an elevation dimension, such that the each SSB beam in the plurality of SSB beams covers the range of azimuth angles in the azimuth dimension and the range of elevation angles in the elevation dimension.

20. The apparatus of claim 17, wherein different SSB beams cover different ranges of azimuth angles or different ranges of elevation angles.

21. The apparatus of claim 17, wherein the plurality of SSB beams corresponds to K SSB beams that cover N ranges of azimuth angles and M ranges of elevation angles.

22. The apparatus of claim 21, wherein the mapping configuration maps K SSB IDs to the K SSB beams initially based on an azimuthal direction and subsequently based on an elevation direction.

23. The apparatus of claim 21, wherein the mapping configuration maps K SSB IDs to the K SSB beams initially based on an elevation direction and subsequently based on an azimuthal direction.

24. The apparatus of claim 17, wherein the plurality of SSB beams are grouped into multiple beam blocks, each of the multiple beam blocks including k SSB beams that cover n ranges of azimuth angles and m ranges of elevation angles.

25. The apparatus of claim 24, wherein the mapping configuration maps k SSB IDs to the k SSB beams in the each of the multiple beam blocks initially based on an azimuthal direction and subsequently based on an elevation direction.

26. The apparatus of claim 24, wherein the mapping configuration maps k SSB IDs to the k SSB beams in the each of the multiple beam blocks initially based on an elevation direction first and subsequently based on an azimuthal direction.

27. The apparatus of claim 24, wherein the mapping configuration maps k SSB IDs to the k SSB beams in a first beam block of the multiple beam blocks before mapping next k SSB IDs to the k SSB beams in a second beam block of the multiple beam blocks, the second beam block being adjacent to the first beam block in an elevation direction or azimuth direction.

28. The apparatus of claim 17, wherein the at least one processor is configured to:
transmit one or more parameters associated with the mapping configuration via a master information block (MIB) or a system information block (SIB).

29. The apparatus of claim 17, further comprising at least one of a transceiver or an antenna coupled to the at least one processor.

30. A method of wireless communication at a network entity, comprising:
mapping a set of synchronization signal block (SSB) identifiers (IDs) to a plurality of SSB beams based on a mapping configuration, each SSB beam of the plurality of SSB beams being associated with one SSB ID of the set of SSB IDs and covering a range of azimuth angles and a range of elevation angles; and
transmitting one or more SSB IDs via the plurality of SSB beams based at least in part on the mapping configuration.
